(19) United States
(12) Patent Application Publication
(10) Pub. No.: US 2009/0029645 A1
(43) Pub. Date: Jan. 29, 2009

(54) Multi-Tier Backhaul Network System with Traffic Differentiation and Advanced Processing Capabilities and Methods Therefor

(75) Inventor: Frederic Leroudier, Pleasanton, CA (US)

Correspondence Address: DLA PIPER US LLP, 2000 UNIVERSITY AVENUE, E. PALO ALTO, CA, 94303-2248, US

(73) Assignee: TeeNay Wireless, Inc., Pleasanton, CA (US)

(21) Appl. No.: 12/180,380

(22) Filed: Jul. 25, 2008

Related U.S. Application Data
(60) Provisional application No. 60/951,924, filed on Jul. 25, 2007.

(51) Int. Cl. H04B 7/14

(52) U.S. Cl. 455/7

(57) ABSTRACT

A multi-tier backhaul system that has compact remote transceivers for providing backhaul or a variety of applications, and connected to a wireless relay module in a point to multi-point fashion, and the other said tier consisting of a plurality of said wireless relay modules connected to a central wireless hub for providing backhaul capabilities to the relay module and remote units thereto connected.

### PRIORITY CLAIM

This application claims the benefit under 35 USC 119(e) to U.S. Provisional Patent Application Ser. No. 60/951,924 filed on Jul. 25, 2007 and entitled “Distributed Wireless Network Architecture Using Integrated Access and Backhaul Modules and Methods Therefor” which is incorporated herein in its entirety by reference.

### BACKGROUND

Wireless networks have relied on a variety of backhaul solutions since their introduction. Backhaul is required to connect multiple base stations in a mobile cellular network to the rest of the network as well as to control functions within the mobile network. The backhaul network is therefore an important part of any wireless network since all control and user traffic transits through this network. As such, the performance and reliability of the backhaul network directly impacts the quality of the mobile service as perceived by users. The efficiency of the backhaul network has a direct relationship with the overall mobile network cost and with the network operator profit margins. In many cases, in fact, the cost of backhaul can make a new mobile application profitable or not.

For the first twenty years since the first wireless networks were deployed, the vast majority of the traffic carried by those networks was circuit-switched voice traffic. As such, the backhaul solutions used for those wireless networks followed the traditional circuit-oriented transmission principle in use in legacy telecom networks. Since recently however, new wireless standards, technologies and applications have emerged that challenge this situation and are making the traditional backhaul infrastructure inefficient and unprofitable.

FIG. 1A shows a known arrangement illustrating a traditional cellular backhaul arrangement, representing a typical cellular network for enabling a plurality of wireless devices to communicate with other devices coupled to the network. As shown in FIG. 1A, there are a plurality of cellular base stations 101, 102 and 103 representing fixed transceivers that communicate with their respective wireless terminals in the geographic locations controlled by each cellular base station. Thus, cellular base station 102 is shown communicating with a mobile station 110, which may represent, for example, a cellular phone or a multimedia mobile device. Cellular base station 102 is also shown communicating with a laptop computer 111, which may be equipped with a wireless receiver or terminal adapter in order to connect to the mobile network. Cellular base station 103 is also shown communicating with another handset 112. The geographic area, within which the handset devices may communicate with cellular base station 102, is called a cell and is denoted as area 114. Similarly area 115 denotes the cell area under which mobile devices may communicate with base station 103. As an example, the range of each cell varies from less than 1 km to more than 20 km, even though general trends are that this coverage area decreases due to increasing capacity and throughput requirements.

In the example of FIG. 1A, cellular base station 102 collects and distributes traffic to and from the mobile devices (110 and 111) and transports it to and from the core network 116 via backhaul link 118, which is typically a line of sight communication link using microwave, and via aggregation point 120 and high capacity backhaul link 122, which may be a high capacity fiber connection or microwave link, and finally via an interconnecting controller 121. Core network 116 represents a collection of routers, switches and servers in the mobile network that also comprises a plurality of high-speed trunks. The wireless network controller 121 is the entity responsible for managing the resources within the wireless network, comprised of the plurality of base stations and the wireless resources they exploit. Similarly, base stations 101 and 103 are backhauled via backhaul links 117 and 119 respectively, and via the aggregation point 120 and high capacity backhaul link 122. Another well-known prior art backhaul method consists of using leased lines, such as E1 or T1 transmission facilities. For instance base station 103 uses leased line 119 to backhaul its traffic to aggregation point 120. Alternative prior art arrangements include topologies consisting of daisy-chained point to point backhaul links and meshed point to point backhaul links.

In some cases, an optional Network Interface Device (sometimes called backhaul switch) 113a is required at the cell site between the base station and the transmission network, or at some aggregation site in the network, 113b, to enhance performance of the backhaul link, particularly for data traffic (the utility and drawback of this approach will be discussed further in this disclosure). The backhaul network in the example of FIG. 1A consists of the backhaul network interface devices 113a and 113b, backhaul links 117, 118 and 119, the aggregation point 120 and the high capacity backhaul link 122.

Although the backhaul network of FIG. 1A has been employed for some time, there are disadvantages. A first disadvantage concerns the type of traffic those networks have been designed for. The cellular base stations, such as cellular base station 102 and cellular base station 103, depend on either a microwave backhaul (as in the case of microwave backhaul 118) or T1 or E1 lines 119 to perform its backhauling task. These technologies are well adapted to a circuit-oriented network and applications, but are neither cost-effective nor scalable enough for bursty high speed packet data traffic. As an increasing number of customers expect to be able to use similar high-speed services as those they are accustomed to on the fixed wireline network, and as new mobile standards are introduced to enable those applications, the backhaul network as described in FIG. 1A becomes a limitation for the provision of those services and for the network operator profitability. Examples of such new mobile standards include High Speed Packet Access (HSPA), 802.11 WiFi, 802.16 WiMAX, Third Generation Long Term Evolution (3G LTE), CDMA EVolution Data Optimized (CDMA EVDO), IEEE 802.20 and Ultra Mobile Broadband (UMB). Example of applications sought by mobile users include high speed internet browsing, video streaming, video broadcasting, fast file transfer, IP telephony and videophone, and interactive gaming.

The traditional architecture of FIG. 1A has further drawbacks. Indeed, another consequence of higher data rates and increasingly demanding mobile applications is a tendency to require smaller cells, driving network operators to deploy dense networks of micro-cells or even pico-cells. The reason for this is increasingly challenging link budgets for indoor and outdoor penetration, and the need for more capacity and bandwidth. In a wireless system, the link budget describes the various parameters affecting the ability of a receiver to correctly decode a signal transmitted by a remote transmitter. Those parameters include transmit power levels, antenna gains, system losses and gains, propagation path loss, penetration loss and receiver sensitivity. Since the transmitted bandwidth is one of the components of a link budget, there is an inverse relationship between system bandwidth and the maximum path loss that a signal is able to tolerate: higher bandwidth thus results in lower minimum tolerable path loss, which in turn means shorter ranges. This is particularly true for indoor coverage due to the high penetration loss into buildings or obstructed areas. This is further exacerbated by the need to use spectrum allocations in higher frequency bands where propagation and penetration characteristics are more challenging than in the lower frequency bands. Because the lower frequency bands, such as the 450, 800, 900, 1,800, 1,900 and 2,000 MHz bands are already occupied by previous generations of cellular systems and do not have sufficient capacity for broadband applications, new services are more likely to be deployed in higher frequency bands, such as 2,300, 2,500 MHz, 3,500 MHz and other bands. It is well known by those skilled in the arts that those higher frequency bands present additional challenges for indoor as well as outdoor coverage in areas where obstructions may exist.

One skilled in the arts will recognize that higher efficiencies can be achieved by using dense networks of very small cells (often called micro or pico-cells depending on their relative size, or even femto-cells in the case of in-building coverage). Average cell radii for micro cells are on the order of half a kilometer while pico-cells are generally between 100 m to 800 m. Femto-cells generally do not exceed 100 m cell radius. The most common measure of efficiency, called spectral efficiency, is defined by the total bandwidth (expressed in Mbps) can be delivered on a given amount of spectrum (measured in MHz). When combined with frequency reuse factors, it is thus possible to determine spectral efficiency over a complete cellular network (which can be designated “overall spectral efficiency”). Micro or pico-cellular networks have a higher overall spectral efficiency because such arrangements will lead wireless terminal devices to operate at lower transmission power and to use more efficient modulation and coding schemes. These solutions also lead to lower frequency reuses because smaller and lower cellular sites create less inter-cell interference. In addition such topologies allow operators to save cost by deploying base station transceivers where they are most needed, as opposed to providing uniform blanket coverage over a wide area, including areas where service is not required. Pico and femto cells are particularly beneficial for providing in-building coverage. There are therefore considerable incentives for mobile network operators to support cellular architectures consisting of a dense network of micro, pico or even femto-cells, if this can be done in a cost effective way.

Shorter cell ranges, and thus more numerous cells pose real challenges to the network operators, in particular due to the need to backhaul a large number of smaller cells and to the lengthy commissioning and installation process of traditional backhaul solutions. With prior art architectures and solutions, it can be seen that the cost of deploying such a network increases linearly with the number of cell sites. Therefore the prior art backhaul systems of FIG. 1A do not offer a cost-effective nor practical solution. In addition, the lengthy process, bulky form factors and lack of flexibility in the installation of traditional point to point microwave solutions are a further impediment to the deployment of efficient broadband wireless systems.

Traditional microwave point to point solutions are especially prone to deployment issues in the case of smaller cells. One skilled in the art will recognize that smaller cell sites require lower antenna installation heights in order to avoid inter-cell interference issues and to better focus the coverage area to a smaller area. Furthermore, a dense deployment of micro-cells cannot be envisaged practically if each cell required a high tower for the backhaul equipment and antennas, especially in a dense urban area. Practical consideration often force network operators to reuse existing infrastructure, such as building walls or roofs, lighting and traffic signaling poles or other urban real estate. A direct consequence of lowering the base station heights is that the wireless links used to connect to these base stations will encounter a higher number of obstructions as other building and other form of clutter will often obstruct the direct line of sight. Since traditional point to point solution require a direct line of sight or near line of sight, it can be seen that these solution will not be able to perform well in those cases.

FIG. 1B provides an illustration of an arrangement for the backhaul of wide area macro-cells and smaller micro-cells. A backhaul hub 301 collects and aggregates traffic from a plurality of cellular base stations in a given urban area through point to point wireless links. Some of these cell sites are high base stations such as 302 used to cover macro-cells such as 303, and connected to the backhaul hub 301 via a point to point microwave link 304. Other base stations such as 305 and 308 are installed at lower heights in order to cover a multitude of micro-cells 306 and 309. In this case a wireless link to the backhaul hub 307 and 310 would not be able to benefit from a direct, unobstructed line of sight link. This means that no reliable communication is possible for the backhaul of these sites using such an arrangement. It can be seen therefore that traditional point to point microwave systems are an obstacle to the deployment of micro-cells in such dense urban areas where they are most needed.

Conventional backhaul solutions are also not practical nor economical for the quick deployment of temporary cellular networks, or in the case when an emergency network needs to be deployed, for instance to restore service to a disaster area, due to the cumbersome installation and planning processes.

FIG. 1C illustrates the bandwidth variation over time on a point to point transmission link used to backhaul bursty data. The bandwidth versus time representation of a typical backhaul link is represented as 201. Due to the burstiness of the traffic, the link will experience short periods where a peak rate 202 will be reached, as represented by data bursts 203 and 204. These moments are however statistically rare and the average data rate 205 over such a link is often much lower than the peak rate. Peak rate is however important from a quality of experience point of view, as this will translate in quicker access to information by the end users, and thus is directly related to the perceived performance and value of the service. With a point-to-point link topology, the unused resources left when the link is not transmitting at peak rate cannot be used by other users, as there are none. It can therefore be seen from the foregoing that the only solution to achieve a high peak rate in such a point to point system is to have a high peak to average rate ratio. Therefore, enabling a high quality of experience to the end users will result in higher backhaul costs in relation to the average data rate to be delivered to the base station.

Yet another factor affecting traditional microwave solutions is the need for low visual and environmental impact that is generally imposed by the local or municipal authorities. Traditionally, microwave solutions require high gain antennas as well as bulky radio components in order to enable longer links (often in excess of 10 km): therefore those solutions are in general inappropriate for dense deployments, for instance in urban areas.

It has been explained above, the evolution of wireless networks favors a more distributed approach consisting of smaller base stations. Because of the reduced need for long range capabilities in those base stations, requirements for transmission power and reception gain are also reduced. This translates into more compact base station equipment due to smaller power amplifier and low noise amplifier components as well as smaller antennas. For instance low-cost and easy to install single unit outdoor or indoor mounted base stations (known in the art as pico base stations or femto base stations) are becoming possible. Traditional backhaul solutions are not well adapted to these new base stations since their own costs become prohibitive and their higher power and larger antenna sizes make their installation more complicated and lengthier than the base station itself, thus canceling their economical benefits. There is therefore a benefit in having shorter “last mile” links in those networks using smaller and more numerous cells. For instance, much lower equipment and installation costs may be achieved if the “last mile” is reduced to a few hundred meters.

Prior art backhaul solutions such as the one illustrated in FIG. 1A fail to address key requirements in yet another way: as long as traditional networks were used for a limited number of circuit-oriented applications such as telephony, leased lines or point to point microwave links offered a straightforward way to engineer backhaul networks for cellular systems. However, recent evolutions in wireless technology, mobile applications and usage trends are leading to a much wider range of applications and thus traffic patterns. The wide range of applications now enabled on the Internet or using the Internet protocol are expected to be enabled on a wireless network with the same flexibility and performance. Such application include web browsing, messaging, file transfer, real time one-way, two way or broadcast video and voice, streaming video or sound files, real time interactive gaming, peer to peer or device to device applications, location services and much more. In all these cases, the traffic characteristics, including bandwidth requirements, latency requirements, maximum error rates, availability, burstiness, etc. vary dramatically. In addition, certain of these applications may require or may benefit from various networking mechanism such as broadcast, multicast, compression, caching, store and forward, transcoding and protocol optimization.

Recent trends in opening programming interfaces of mobile devices and the availability of new types of devices (including wireless adapters for laptop computers) are further exacerbating the problem by making it difficult or even impossible for network planners to predict and act on the amount and type of traffic generated by the mobile devices. With such open access to wireless networks, any software developer can create and distribute applications on mobile terminals that may generate unpredictable and variable traffic patterns. Therefore operators using the traditional architecture of FIG. 1A are losing the ability to predictably manage and optimize the network resources comprising the backhaul network, and to engineer the network in order to meet performance and business objectives. This is because the transmission links such as 118, 119 and 122 are not able to differentiate between the various types of traffic or users and therefore are not able to take specific actions depending on it. In addition, not having the ability to monitor the traffic type based on application or user category, and to act on it in real time basis prevents operators from correlating network usage to revenue or business opportunities (for instance by ensuring sufficient bandwidth is made available to premium users even in the case of network congestion).

Because prior art solutions are generally unable to differentiate between various sorts of traffic elements, they lack the ability to handle the transmission of backhaul data according to a variety of criteria. Examples of differentiated handling include using different physical layer attributes such as burst sizes, modulation, coding type, polarity, power levels; using specific retransmission or diversity algorithms; using various scheduling or admission control techniques; performing traffic shaping; performing protocol optimization at various layers; filtering out some traffic elements; selectively routing the traffic; using broadcast or multicast delivery techniques, selectively buffering, caching or compressing the transmitted data; transcoding of digital voice, sound or video signals, scheduling; and various other tasks. Such differentiated handling tasks may be used within the backhaul network in order to increase system efficiency, or to enhance service performance or quality of experience.

Prior art backhaul solutions such as leased lines or conventional point to point microwave links do not provide the mobile operator any flexibility to be easily reconfigured by the network operator in order to increase the efficiency and performance under new types of traffic characteristics resulting from new applications or usage. This is another consequence of the fact that prior art backhaul systems are pure transmission systems and thus are not able to differentiate between the information elements transiting across the network according to their content or their origin. They also lack any sort of configurable traffic processing functions which are necessary to provide network operators the tools to efficiently manage their network in the presence of ever-changing traffic patterns and requirements. As such operators are not able to implement differentiated policies for transmitting information across the backhaul network, nor to easily change the way those policies are implemented or configured.

Prior art solutions being mostly based on point to point transmission links, whether wireline or wireless, lack an efficient method for handling broadcast or multicast transmissions, as may be the case for example for video services. In order to transmit a broadcast traffic flow over a given area, it is necessary with those solutions to replicate and transmit the flow of information to as many destinations as required. This results in bandwidth being wasted when transmitting broadcast traffic to a plurality of backhaul sites. It should be noted that the wasted bandwidth is a function of the number of backhaul sites and as such increases with the density of those.

Several solutions have emerged introducing devices at the base station cellular sites and within the network, in order to regulate the data transiting over the backhaul network on an end-to-end basis. This is the function of backhaul switches 113a and 113b in FIG. 1A. These devices then connect to a conventional backhaul solution such as a leased line or microwave point to point link, such as 118 in FIG. 1A. These types of solutions fall short of providing a complete and economical solution however since they increase equipment, installation and management cost, and do not allow for an optimization of the backhaul network resources. Since these devices are by definition separate and often remote from the transmission link itself, they lack the capabilities to influence basic layer 1 and layer 2 functions such as link parameter adjustment, resource allocation, retransmission policies, scheduling and admission control, buffering, link selection and reselection, use of optimized transmission topologies such as broadcast or multicast, and more. As such, these devices fall short of providing an efficient method to improve performance, efficiency, resiliency and quality of service within the backhaul network. This is particularly true in the case of a wireless transmission within the backhaul network, as this medium is well known to be subject to sudden and large variations which can only be managed efficiently at the lowest layers of the wireless protocol stack, within the wireless equipment itself. These variations are due to impediments on the wireless medium such as interference, fading and other phenomena. A non integrated prior art solution such as the one using interface devices 113a and 113b in FIG. 1A therefore does not have the capability of adjusting wireless parameters and processes in real time, and is therefore not able to optimize system performance, quality of service, resiliency and efficiency of the wireless backhaul network.

Yet another drawback of conventional backhaul solution is the lack of routing capability within the various nodes forming the transmission network. Historically, a hierarchical structure was used for cellular networks, whereby all radio base stations would connect to a Base Station Controller or Radio Network Controllers, and those controllers would connect to a network switch capable of handling the service requests and routing the voice or data calls on the core network. As such, all traffic had to be routed systematically to and from this controller. There is however a strong trend to flatten this architecture and distribute the Base Station or Radio Network Controllers within the base station equipment itself. As such modern and future base stations may have a direct interface to the core network and therefore not require a connection through a controller unit. Since conventional solutions are not able to process network level information, they can only transmit the data to an aggregation point and back, at which point, this data may be sent back to another or the same base station, resulting in wasted bandwidth. One example of scenario where routing within the backhaul network is beneficial is the case of the transmission of radio and handoff information between cells within the cellular network. By not having to transfer these messages and their data up to a hierarchical controller, capacity can be saved on the backhaul network and latency can be reduced.

Other prior art wireless backhaul solutions have emerged using WiFi-based self-provisioning mesh configurations in order to realize a backhaul network for macro and micro-cells. These systems are based on IEEE 802.11 wireless LAN technology and are limited to point to point connectivity between the various units and generally require using different frequencies on each of the mesh hops. As a result, these systems often require complex and costly RF equipment capable of supporting a large number of RF channels and are only available in unlicensed frequency (especially since these architectures do require a large number of RF channels). Furthermore, since these solutions use a MAC layer based on point to point transmission, they are not a good solution for broadcast and multicast traffic. In addition, since those systems are deployed in clusters within which backhaul traffic is aggregated, a separate backhaul solution for each cluster is still required, with the disadvantages as explained previously.

Another form of prior art used for backhaul consists of using standard IEEE 802.16 systems as point-to-multipoint backhaul links. While these systems provide adequate broadband access capabilities, they fall short of meeting basic requirements in the areas of redundancy, latency, capacity and network management. Furthermore, they do not provide a complete network solution including resiliency and routing as highlighted previously.

As a summary, a new backhaul model is required in order to enable the next generation of wireless services. This new backhaul model needs to support a more distributed network of micro, pico or even femto base stations in an economic way, and to provide a more flexible and dynamic way for operators to manage their network for a wide range of traffic and quality of service requirements. A system and method that can provide those attributes is described below.

### BRIEF DESCRIPTION OF THE DRAWINGS

FIG. 1A shows a known arrangement illustrating a traditional cellular backhaul network, representing a typical cellular network for enabling a plurality of wireless devices to communicate with other devices coupled to the network and the backhaul links needed to interconnect those site to the rest of the network.

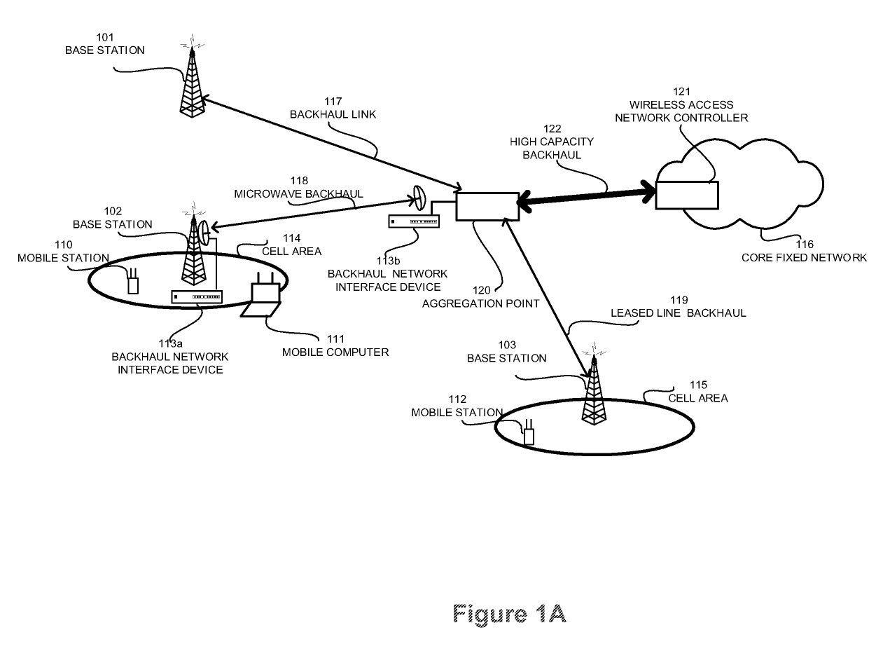

FIG. 1B shows a typical urban deployment of a cellular network including macro and micro cells and their connections to a backhaul hub.

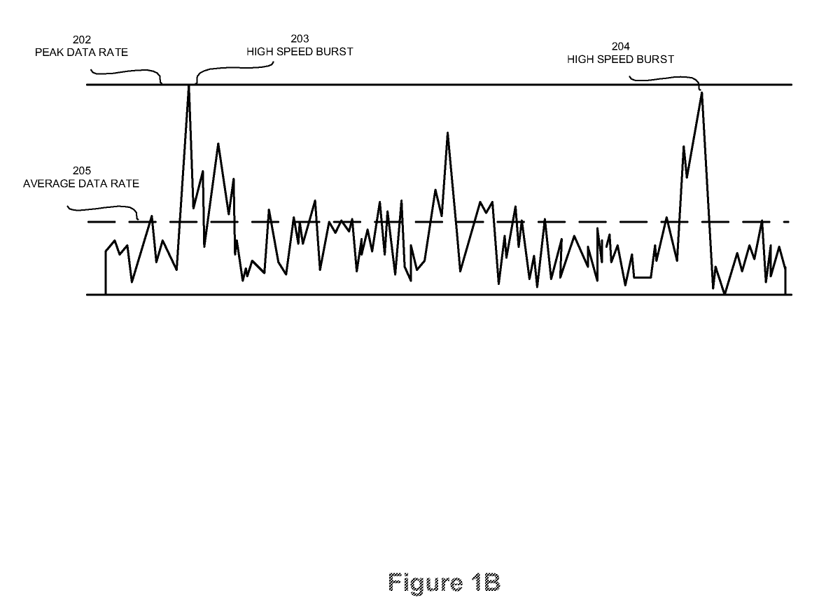

FIG. 1C shows a graphic representation of the wireless bandwidth usage in a point to point backhaul link used to transmit bursty data traffic.

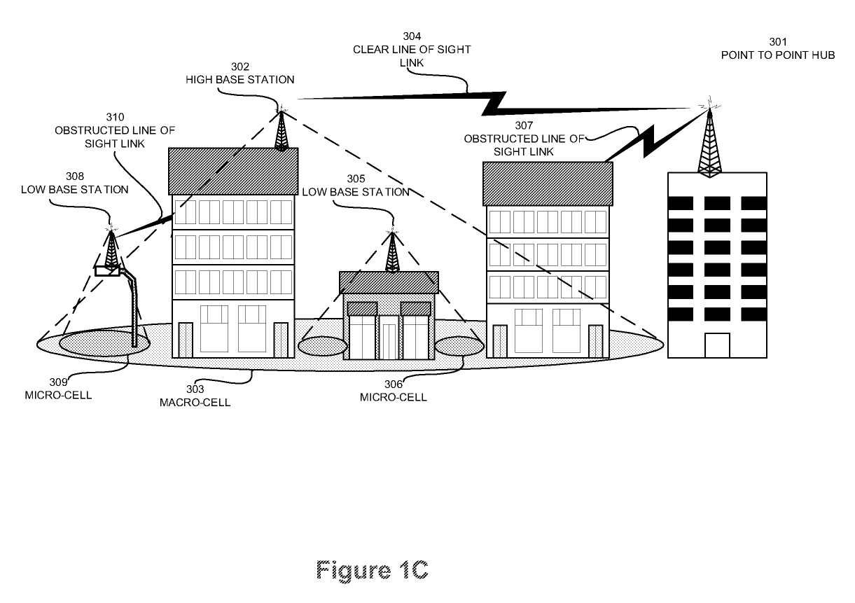

FIG. 2A shows a general architecture of an advanced next generation backhaul network using a multi-hop and multipoint topology, and consisting of a plurality of Wireless Remote Backhaul Modules, Wireless Relay Backhaul Modules and a Backhaul Hub Unit.

FIG. 2B shows a graphic representation of the wireless bandwidth usage in a point to multi-point backhaul network used to transmit bursty data traffic with burst-based bandwidth allocation

FIG. 3 shows an urban deployment benefiting from an advanced next generation backhaul network.

FIG. 4 shows a comparison between a conventional hub-based point to point transmission topology, and a two-tier topology using a mix of point to point and point to multipoint transmission links.

FIG. 5A shows a functional description of the backhaul network including a plurality of Backhaul Remote Modules, a plurality of Backhaul Relay Modules and a Backhaul Hub Unit.

FIG. 5B shows a functional description of the management structure of a backhaul system.

FIG. 6 illustrates backhaul relay module details.

FIG. 7A shows an example of a method for transmitting a backhaul traffic flow corresponding to a particular application.

FIG. 7B shows an example of a method for configuring, commissioning and setting up a backhaul system so as to enable backhaul transmission.

FIG. 7C illustrates an example of the redundancy process.

FIG. 8A is an example of a backhaul relay module.

FIG. 8B illustrates more details of the backhaul relay module.

FIG. 8C illustrates more details of the backhaul hub.

FIG. 8D represents an example of a Backhaul Remote Module as part of an embodiment of the system using a wireless downhaul interface.

### DETAILED DESCRIPTION OF ONE OR MORE EMBODIMENT(S)

The system and method are described below in detail with reference to a few embodiments thereof as illustrated in the accompanying drawings. In the following description, numerous specific details are set forth in order to provide a thorough understanding of an example of an implementation of the system and method in the context of a wireless cellular system. It will be apparent, however, to one skilled in the art, that the system and method may be practiced without some or all of these specific details.

Various embodiments are described herein below, including methods and techniques. It should be kept in mind that the system and method might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the system and method may also cover apparatuses for practicing embodiments of the system. Such apparatus may include circuits, dedicated and/or programmable, to carry out tasks pertaining to embodiments of the system. Examples of such apparatus include a general-purpose computer and/or a dedicated computing device when appropriately programmed and may include a combination of a computer/computing device and dedicated/programmable circuits adapted for the various tasks pertaining to embodiments of the system and method.

Methods and apparatus for backhauling traffic from a distributed network of nodes acting as traffic sources or sinks (“the Backhauled Network”), from or towards one or a plurality of aggregation hubs, and from there to a core network are described. Traffic coming from or destined to the distributed network nodes may bear a wide range of characteristics and the topology of the backhauled network may include nodes of various sizes and capacity. Examples of such nodes acting as traffic sources and sinks include mobile cellular network base stations of various sizes and capacity, wireless internet access nodes, wired or cabled access nodes such as DSL Access Multiplexers or Cable network Headends, video cameras, home-based devices such as femto-cells, WiFi access points or Internet Access Devices, and other devices. Although the illustrative implementation described below is a network to backhaul mobile cellular traffic, the claims made herewith shall not be limited to such application since it can be used with wireless internet access nodes, wired or cabled access nodes such as DSL Access Multiplexers or Cable network Headends, video cameras, home-based devices such as femto-cells, WiFi access points or Internet Access Devices, and other devices.

A few characteristics of an embodiment of the backhaul system include a multi-tier network architecture, support for both point to point and point to multipoint topologies with in-band or out of band relay techniques, resilient self healing processes, optimized flow-based routing and relaying in the various backhaul network components, application and user specific traffic and Quality of Service (QoS) handling, protocol optimization and data processing techniques within each network component.

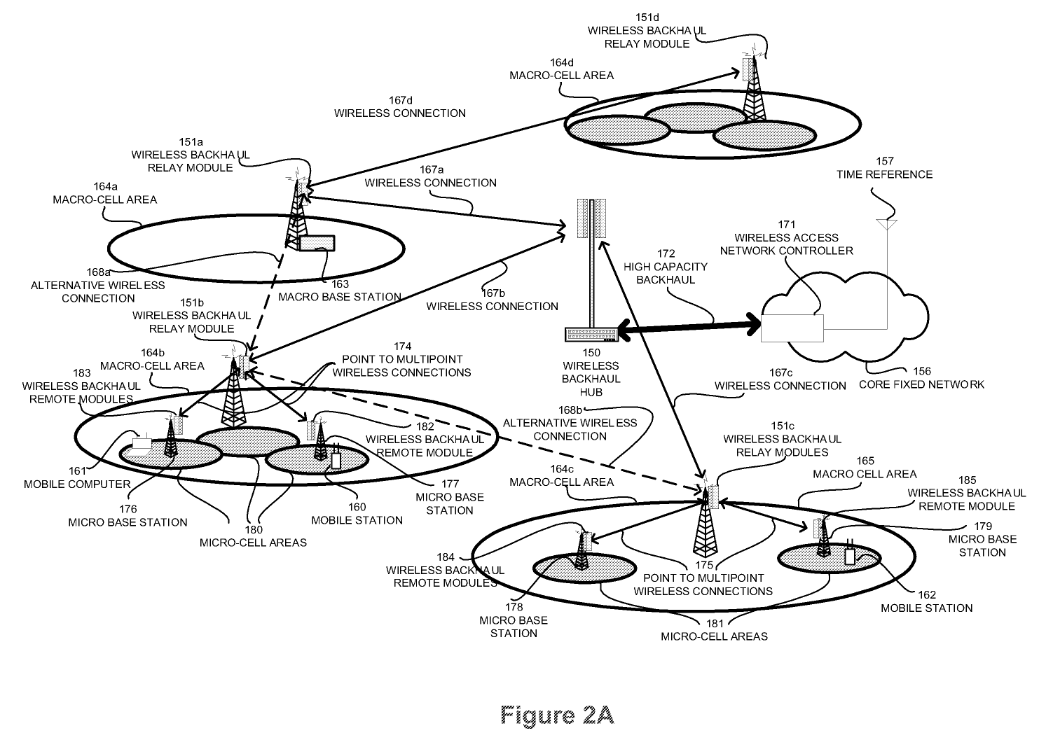

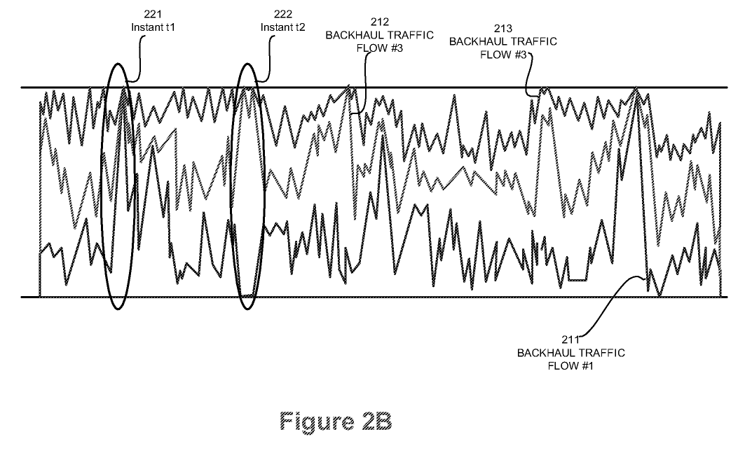

General Description: FIG. 2A shows an example of an implementation of an embodiment of a multiple tier backhaul architecture for a wireless cellular system that employs a Backhaul Hub Unit (Hub) 150, one or more integrated Backhaul Relay Modules (Relays) 151 such as 151a, 151b, 151c and 151d, and one or more Backhaul Remote Modules 180 (Remotes), such as 181, 182, 183, 184 and 185, co-located with traffic sources or sinks such as cellular base stations or micro base stations, such as to implement a distributed wide area wireless backhaul network. The architecture of FIG. 2A may be thought of as a multi-tier system wherein Hub 150 is employed to communicate with a plurality of Relays 151a, 151b, 151c, 151d, etc. via connections 167a, 167b, 167c and 167d respectively, and where those Relays are employed to communicate with a plurality of Remotes 182, 183, 184 and 185 via Point to Multi-Point (PMP) wireless connections 174 and 175, or to connect directly with traffic sources or sinks, such as macro BS 163, in order to realize a backhaul connection. Although only four relays and four remotes are shown to illustrate the system, a typical Hub may control many more Relays and many more Remotes. Depending on a variety of factors, including frequency of operation of the wireless links, traffic density and terrain, the typical distances between a Hub and a Relay may range from a few kilometers to more than 30 kilometers, and the typical distances between a Relay and a Remote may be for example half a kilometer in radius.

Connectivity between the Relays and Hub 150 may be direct, as in the case of 167a, 167b and 167c or may use a chained or meshed configuration as in the case of 167d. In one particular embodiment a wireless connection may be used to link Relays with a Hub, however any high speed link capable of transmitting data traffic and meeting the requirements specified in this description is also possible.

In an embodiment, Hub is connected to a core network 156. Hub 150 is also connected to a time reference, 157, for the purpose of providing timing reference to the whole network it is connected to.

The Remotes 180 are connected to external network nodes acting as traffic sources or sinks in order to realize a backhaul connection. In the embodiment illustrated in FIG. 2A, the traffic sources and sinks are represented as cellular base stations as part of a cellular mobile communication network. However, this is only an example, and any other network nodes acting as a source or sink of data or information traffic may be used with the multi-tier backhaul network wherein the source or sink of data or information traffic may include larger cellular base stations (macro base stations, designed to cover areas with radiuses of tens of km), Wireless LAN access points, wireless internet access nodes, wired or cabled access nodes such as DSL Access Multiplexers or Cable network Headends, video cameras, home-based devices such as femto-cells, WiFi access points or Internet Access Devices, and other devices.

In one embodiment, each Remote 180 is responsible for interfacing with the backhauled network nodes, for classifying the incoming data, for terminating the Point to Multi-Point wireless connection with the Relay and for performing a variety of operations on the backhauled traffic data and control signals. For example, rate limiting and traffic shaping may be done.

FIG. 2A shows Remotes 182, 183, 184 and 185 connecting backhauled network nodes 176, 177, 178 and 179 via a standard local interface such as Ethernet, or E1/T1, PDH, SDH or a combination of those. In the backhaul architecture corresponding to a particular embodiment, the Remotes are designed to be connected to micro-cells, pico-cells or even femto-cells, in which each subsequent cell in the list is a cell with typically smaller radius and limited capacity. In other applications, Remotes 180 may be connected to any other traffic sources or sinks, such as larger cellular base stations (macro base stations, designed to cover areas with radiuses of tens of km), Wireless LAN access points, wireless internet access nodes, wired or cabled access nodes such as DSL Access Multiplexers or Cable network Headends, video cameras, home-based devices such as femto-cells, WiFi access points or Internet Access Devices, and other devices. In yet another embodiment, the Remote units may integrate a mobile base station within its physical enclosure in order to provide an integrated backhaul and access wireless node. This particular embodiment has the advantage of saving equipment and deployment costs. Additional benefits include a better integration of backhaul and management functionalities allowing higher efficiencies, enhanced Quality of Service support and easier management features.

In the backhaul system, each Relay 151 is responsible for controlling one or more communications channels (which may be wireless or wired in different embodiments) to communicate with the Remotes 180 using a Point to Multi-Point method and protocol described below; for routing backhaul traffic and for relaying the aggregated data on a wireless or wireline interface towards a higher level concentration hub. Alternatively, a Relay 151 may implement the functions of a hub in order to connect directly to the network.

In this description, “routing” refers to a layer 3 process while relaying refers to a process involving lower layers as well. In an embodiment, a Relay 151 may generally include functionalities and hardware to implement a high speed data link for backhauling the aggregated traffic towards a hub, for instance using a wireless medium. Each Relay 151 is also responsible for ensuring end-to-end Quality of Service requirements and for performing a variety of control and user data processing on the backhaul traffic flows. Optionally, a Relay may also provide an external interface for connecting a backhauled network node, in a similar way as a Remote: the example in FIG. 2A shows Relay 151a backhauling macro base station 163 providing coverage to macro-cell 164a. A Relay may also connect to other backhauled network node such as micro or pico base stations, wireline network nodes and other equipment.

The Hub 150 is responsible for collecting backhauled traffic from one or more Relays 151, for routing, and for backhauling the aggregated data on an external backhaul interface, towards a higher level node in a core network 156. In addition the Hub is responsible for classifying data from the core network, in a similar way as the Remotes, as well as for various other networking and data processing tasks.

Point to Multi-Point Downhaul Interface: Each of the Relays connects (wirelessly in the illustrative embodiment, but the connection may also be wired) in a point to multipoint fashion to a plurality of Remotes so that, for example Relay 151b connects to Remotes 182 and 183 via Point to Multi-Point (“PMP”) interface 174 using a PMP mode; and Relay 151c connects to Remotes 184 and 185 via Point to Multi-Point interface 175 using a PMP mode. The Point to Multi-Point mode refers to a communication mode where a single entity communicates with several other entities using a shared communication channel. In an embodiment, Relay 151b (and Relay 151c) controls the communication with all Remotes that are in the coverage area of the particular Relay, such as Remotes 182 and 183 and 184 and 185, respectively. As such, the Relays are responsible for providing a centralized timing reference, for granting access and allocating wireless resources, and for scheduling traffic to and from the Remotes under their control. In some embodiments and implementations, a Relay may be equipped with a single or with a plurality of channels depending on coverage and capacity requirements. Examples of these Relays when using a wireless channel may include single-channel Relays with an omni-directional or sector antenna, or a multiple channels Relays deployed in a sectorized manner and with corresponding sector antennas.

The benefits of using a Point to Multi-Point interface (which may be wireless) include higher efficiencies and lower deployment costs. A well known advantage of point to multipoint topology is that only one endpoint needs be installed once the Relay has been installed and commissioned, thus reducing the equipment cost and installation cost and duration for each remote. Another advantage is the ability to easily and efficiently deliver broadcast and multicast traffic by allocating a pre-defined set of resources for all remotes in the broadcast or multicast group. The point to multi-point interface linking the Relays to the Remotes can be called a “downhaul interface” to distinguish it from the wireless link between the Relays and the Hub, called an “uphaul interface”.

FIG. 2B illustrates the efficiency gain achieved by using a point to multipoint topology in the backhaul system. In this figure, several backhaul traffic flows are transmitted on the same backhaul interface: backhaul traffic flow #1, 211 originates from a given Wireless Backhaul Remote Module and terminates at the Wireless Backhaul Relay Module, backhaul traffic flow #2, 212 originates from another Remote and terminates at the same Relay, and backhaul traffic flow #3, 213 originates from yet another Remote and terminates at the same Relay. Each traffic flow contends for the same bandwidth available from the shared channel. The Relay is thus able to take advantage of variations in each of the traffic flows in how it schedules and allocates bandwidth to all backhaul traffic flows.

It can be seen for example that at instant t1 (221), traffic flow #1 is transmitting at peak rate while the other traffic flows do not require as much bandwidth. At instant t2 (222), traffic flow #2 is transmitting at peak rate while the other traffic flows are not transmitting. This allows the point to multipoint system to serve multiple traffic flows using the same amount of bandwidth required for a point to point system, thus achieving a statistical multiplexing gain. The topology used in an embodiment of the system can therefore increase the efficiency and reduce the cost of a backhaul network when used for bursty traffic.

Uphaul interface: Each of the Relays is connected to the core network through a network consisting of one or several connections, arranged in either a hub and spoke configuration, a daisy-chained configuration or a meshed configuration or other topologies well known in the arts, and via Hub 150. According to an embodiment of the system, a wireless medium will be used for the uphaul interface.

As can be seen, the backhaul network represented in FIG. 2A consists of several subsystems at different hierarchical levels: the sub-system consisting of a Backhaul Relay Module, 151b for example, and all the Backhaul Remote Modules connected to it, 182 and 183 for example, can be called a micro-cellular sub-system; and the system consisting of the Backhaul Hub Unit 150 and all Backhaul Relay Modules connected to it, 151a, 151b, 151c and 151d can be called the macro-cellular level. The network system represented in FIG. 2A as an embodiment of the system integrates both micro and macro sub-systems to provide a complete backhaul solution for macro and micro, pico or femto cells. As can be appreciated from the foregoing, the particular embodiment illustrated relies on a backhaul network consisting of two tiers. It should however be understood that each tier in this network may use several hops, as for example would be the cases when the Relay is connected to the Hub via a daisy-chained series of links.

The link between Hub 150 and Relays 151, 152 and 153 is called the “uphaul interface’. According to one embodiment, it is a point to point or point to multipoint interface, which may use the same channel, a different channel, or a channel in a different frequency band as the downhaul interface as several configuration options. When the uphaul interface uses the same channel as the downhaul interface, the terminology of in-band uphaul is used. In the case where a different wireless channel, whether in the same frequency range or in a different one, the arrangement shall be designated as “out of band uphaul”. In addition, the possibility exists to have a backup uphaul interface providing path redundancy from a given Relay to the Hub via another Relay, such as those illustrated as 168a and 168b.

In-band uphaul option: More details on the in-band uphaul mode of operation and possible embodiments are provided further on in the disclosure. It will be appreciated that this mode represents an optional configuration for the system that is made available to network operators as an alternative to out-of-band uphaul, and that it does not adversely impact any of the other processes and mechanisms described herein.

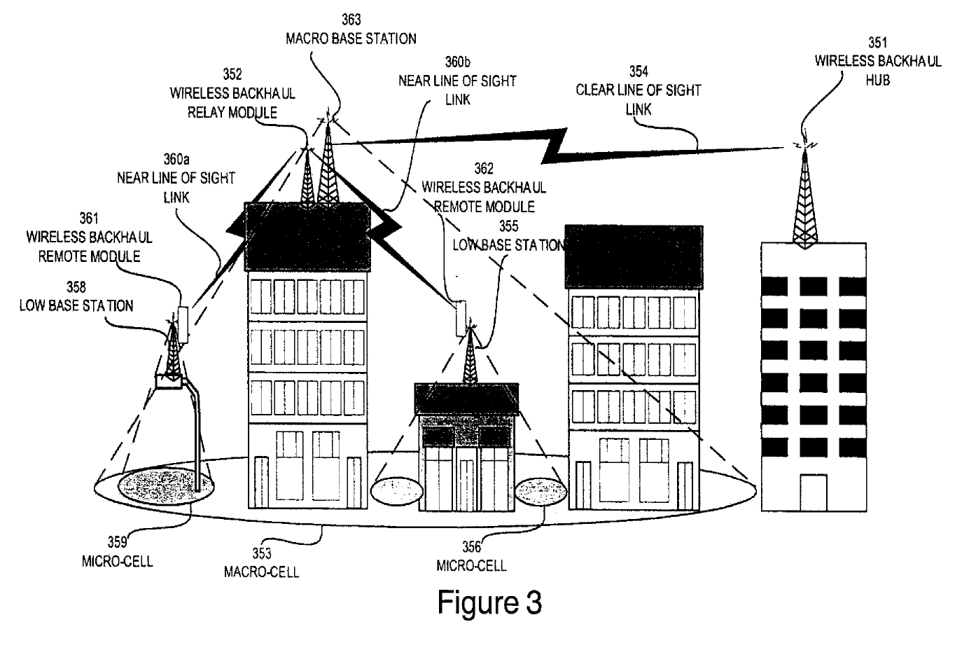

Benefits of the System: FIG. 3 shows how an embodiment of the system provides a practical solution to the problem of micro or pico-cellular sites installed at relatively lower elevations. Backhaul Hub Unit 351 collects and aggregates traffic from a plurality of Backhaul Relay Modules such as 352 using for example a wireless connection for the uphaul interface, typically via antennas having a clear line of sight to the Hub's antennas. Relay 352 connects to a plurality of Remotes such as 361 and 362 for example using a wireless connection, themselves connected to small base stations 355 and 358 covering micro-cells 356 and 359 respectively. In this example, Relay 352 also connects with a macro base station 363 covering macro-cell 353. Because link 354 has clear line of sight and links 360a and 360b have near line of sight over a relatively short distance, they all benefit from propagation conditions compatible with high availability and high efficiency, as required for backhaul applications. The proposed two-tier architecture therefore provides an efficient method for connecting low backhauled network sites via a wireless backhaul infrastructure.

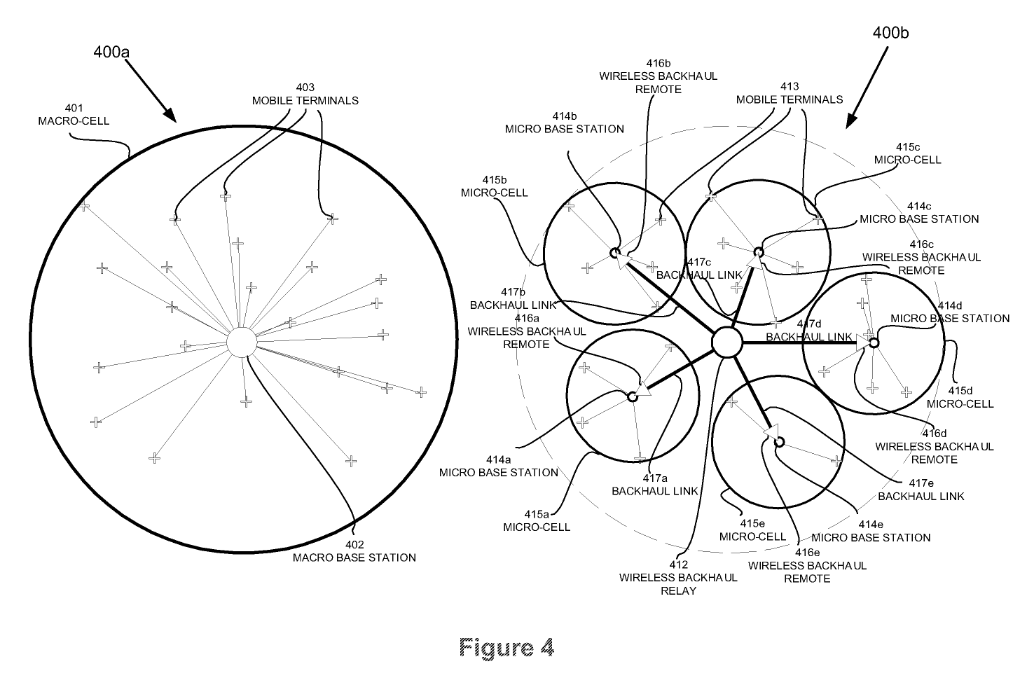

FIG. 4 illustrates how an embodiment of the system increases the coverage and efficiency of a cellular network using an embodiment of the system. In a system 400a shown in the figure on the left, macro base station 402 provides wireless service over a wide coverage area called macro-cell 401, serving a large number of wireless terminals 403. As a typical example, the number of wireless terminals served by a macro base station will exceed multiple hundreds of wireless users. Due to the widespread nature of those terminals 403, macro base station 402 will not always be able to provide the best connection to those users, especially for those nearer the edge of the cell, thus reducing overall network efficiency. In addition, coverage of indoor and cluttered areas will be challenging, due to the unfavorable pathloss and in-building penetration losses.

In a system 400b as shown in the figure on the right, the same wireless terminals, here identified as 413 being served by a plurality of micro base stations 414a, 414b, 414c, 414d and 414e, each covering respectively micro-cells 415a, 415b, 415c, 415d and 415e. Each micro base station is directly connected to Remotes 416a, 416b, 416c and 416d respectively, for their backhaul connection. For viewing convenience and clarity, only the downhaul portion of an embodiment is shown here, therefore the uphaul link connecting Relay 412 to a Hub is not represented. Those remote units act as the end-point of a point to multipoint wireless connection to Relay 412. The point to multipoint wireless connections are represented as 417a, 417b, 417c and 417d respectively.

As can be seen in this figure, Relay 412 controls approximately the same amount of traffic as macro base station 402 in system 400 in FIG. 4A, but in this case, the traffic is distributed between a plurality of smaller base stations in various geographical locations within the macro-cellular area. As noted earlier, using smaller base stations ensures a higher spectral efficiency due to the more advantageous link budgets between the wireless terminals and the micro or pico base stations, and the generally lower interference levels between the micro or pico-cells. An embodiment of the system 400b therefore enables a more efficient method for deploying a network, such as a wired or wireless network.

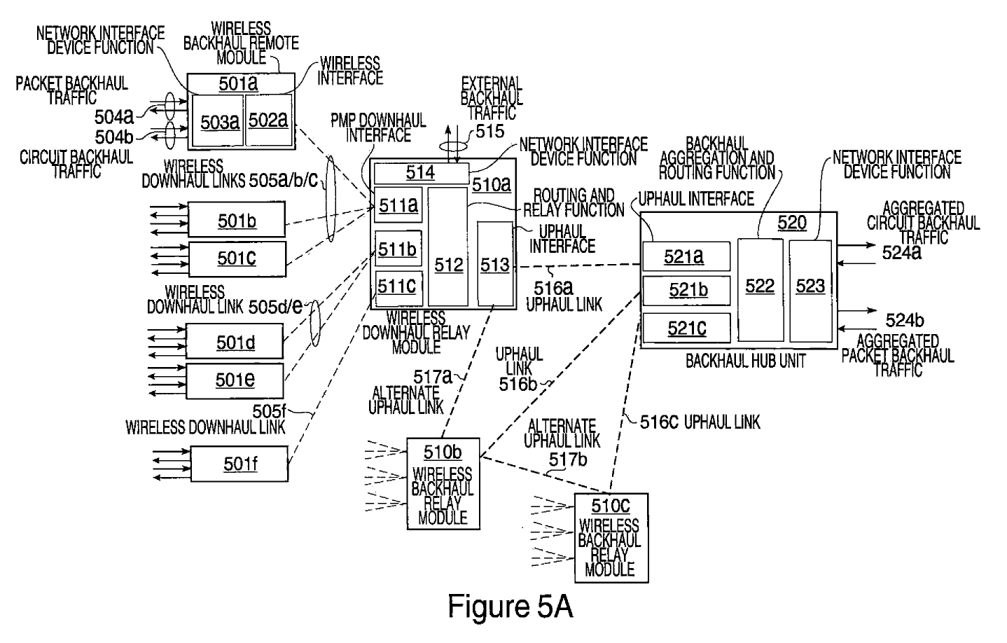

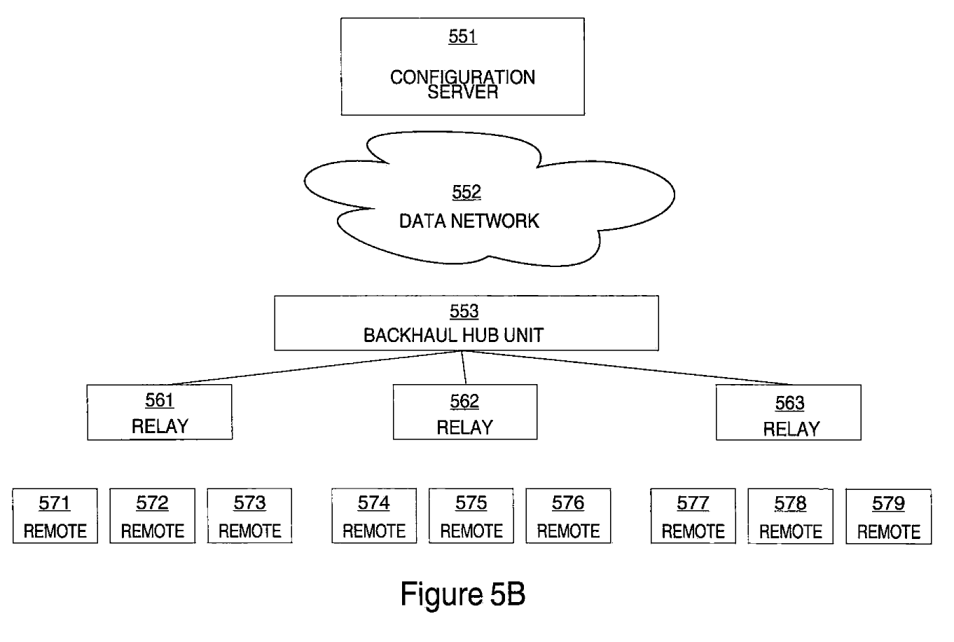

System description: FIG. 5A is a functional representation of an embodiment of the system, showing a central Backhaul Hub Unit 520 connected to a plurality of Wireless Backhaul Relay Modules 510a, 510b and 510c via uphaul links 516a, 516b and 516c respectively. Alternate uphaul links 517a and 517b may provide a direct or indirect redundant path from Relay 510a towards Hub 520. In one embodiment, those uphaul links will use a wireless medium, although any combination of any other high capacity transmission medium with the characteristics specified in this description may be used. One particular Relay, 510a, is configured with three Point to Multi-Point Wireless Downhaul Interfaces, 511a, 511b and 511c. Although this example describes a configuration with three downhaul interfaces, nothing prevents an embodiment from being configured with any other number of such interfaces.

Within Relay 510a, PMP Downhaul Interface provides wireless connectivity to three Remotes, 501a, 501b and 501c via Point to Multi-Point links 505a, 505b and 505c respectively. Similarly, Relay 510a uses the other Point to Multi-Point Wireless Interfaces 511b and 511c to implement downhaul links 505d/e and 505f terminating at Remotes 501d/e and 501f respectively. In the embodiment shown, the PMP links are wireless.

Backhaul Remote Module (Remote): Focusing on Wireless Backhaul Remote Module 501a, it can be seen that this node is used to backhaul incoming and outgoing traffic 504a and 504b. These traffic flows are representing a circuit-based interface, such as a E1 or T1 interface for instance, and a packet-based interface, such as Ethernet, respectively. Remote 501a is thus responsible for managing those traffic flows, in view of carrying them to their intended destination, via Wireless Interface function 502a, and from here on via a Backhaul Relay Module and a Backhaul Hub Unit.

As can be seen, a single Remote may provide backhaul service to a plurality of incoming and outgoing traffic flows, such as 504a and 504b in FIG. 5A. One example of this would be the case of a cellular site with voice and data capabilities, whereby the T1 or E1 interface would be used to transmit the voice traffic and the Ethernet interface would be used to transmit the data traffic. While this example shows two types of traffic flows and interface, an embodiment of a Remote may support more than two interfaces or interface types.

As can be seen from FIG. 5A, Remote 501a in this embodiment integrates a Network Interface Device function 503a in addition to an Interface 502a. All other Remotes, 502b to 502f also include a Network Interface Device and Interface functions, although these have not been represented on this figure for purpose of clarity.

Interface: The Interface function is responsible for the transmission of traffic data across the Point to Multi-Point downhaul interface, 505a, 505b and 505c, under the control of Backhaul Relay Module 510a. One skilled in the arts will recognize that such a function may be implemented by specialized processors integrating all elements of the physical layer and MAC layer functions at the baseband level, coupled with a radio transceiver connected to one or several antennas. In an embodiment, the traffic to be sent across this Point to Multi-Point wireless interface may be structured in data bursts of varying sizes, and those bursts further organized in data frames as part of a multiple access, multiplexing and duplexing scheme. An example of the protocol used to implement the Point to MultiPoint Downhaul wireless channel is described in the IEEE 802.16 specifications, which offers a scheme and protocols for both Frequency Division Duplex (FDD) and in Time Division Duplex (TDD) modes, both of which are compatible with an embodiment of the system. In particular the layer 2. Medium Access Control (MAC) mechanisms of this standard specification, based on a dynamic “on demand” Time Division Multiple Access (TDMA) frame structure, with optional Orthogonal Frequency Division Multiple Access (OFDMA) may be used as part of an embodiment of the system, in order to realize the downhaul wireless interface, as well as possibly the uphaul interface. Use of this protocol however does not exclude other similar standard or proprietary protocols, as long as they are designed to allow a central entity to act as a controller for the assignment and management of wireless and bandwidth resources to the remote units under its control. For instance, proprietary optimized extensions of the IEEE 802.16 standard may be used in an embodiment.

Network Interface Device: Looking at Remote 501a, Network Interface Device Function 503a is capable of reading the combined flow of control and traffic information transiting on interfaces 504a and 504b, and of separating this combined flow into several logical flows, herein called “Backhaul Service Flows” depending on the control information or content of the backhaul traffic.

One skilled in the arts will recognize that such Network Interface Device function may be implemented by a set of standard interface modules or adapters, and by software implemented on a programmable network processor or similar device. Since the network processor may also be used to handle other tasks such as some of the Media Access Control (MAC) functions relative to the wireless interface, or integrated as part of a single processor handling all wireless functions, Network Interface Device Function 503a may not always be a physical entity, but a functional one. An embodiment of the system shall however not be limited to those implementation options, herein provided by way of example.

Since the backhaul traffic data 504a and 504b flowing on Network Interface Device function 503a consists of both circuit-oriented synchronous traffic flow, as in the case of T1 or E1 interfaces, and asynchronous packets of data, as in the case of an Ethernet interface, the Network Interface Device function 502a of Remote 501a is capable of handling simultaneously multiple interfaces and to combine the data within the wireless frame prior to transmission over the wireless interface. While the input of the interface function may consist of multiple different ports, Network Interface Device function 503a is responsible for managing a single output to the Wireless Interface 502a while respecting the required characteristics of each traffic flow. This may be achieved in an embodiment by reserving a range of Backhaul Service Flows for the circuit-oriented interface or interfaces, whereby said Backhaul Service Flows reflect the nature of the traffic.

As will be seen, other system components such as the Wireless Backhaul Relay Modules and the Backhaul Hub Unit also include a Network Interface Device Function with capabilities similar to those described above.

Classification: The process of separating ingressing traffic flows into multiple Backhaul Service Flows is called “classification”. It may use a variety of parameters taken either from the protocol or control overhead used to carry the backhaul traffic, or from an analysis of the flow of incoming or outgoing data itself, and it may be fully configured remotely by a network operator. In particular, so-called “Deep Packet Inspection” techniques may be employed in order to analyze the content of the traffic flows and to differentiate certain traffic elements within this flow. External parameters or measurements may also be used to influence the classification operation. Marking of the data elements guarantees that Backhaul Service Flows are well identified throughout the system. The result of the classification operation may also be used to set other signaling elements in order to inform Relay 510a of actions to be taken for all traffic elements belonging to the given Backhaul Service Flow. This allows Relay 510a to also apply a differentiated handling to the corresponding traffic elements without requiring additional classification or analysis of the data contained in the backhaul traffic.

The classification operation is performed within each of the Remotes where the backhauled data enters the backhaul network, in order to allow network operators to intervene at the traffic source and to ensure end-to-end QoS. Since these actions may be configured remotely by a network operator, the disclosed system provides a flexible and scalable way to manage an entire backhaul network compatible with a wide variety of broadband wireless applications.

Backhaul Service Flows: Backhaul Service Flows are used to define an end-to-end backhaul connection through the system, characterized by a number of Quality of Service (QoS) attributes, including class of service, minimum and maximum data rates, maximum latency and jitter, maximum tolerable error rate and other characteristics, and by various other networking parameters, including routing options, broadcast and multicast options, etc. Those attributes may be assigned to Backhaul Service Flows by remote configuration.

Once the backhaul traffic data has been separated by the Network Interface Device Function into a plurality of Backhaul Service Flows, the logic within Network Interface Device Function 503a may block, re-route or alter certain traffic flows before they are forwarded to the wireless interface 502a, and transmitted over the downhaul interface 505a, towards Relay 510a.

Examples of operations that may be invoked by Network Interface Device 503a depending on the result of the classification operation include filtering, rate limiting, traffic shaping, compression, caching, protocol optimization, transcoding, specific routing, monitoring, storage, etc. Some of these operations may require additional hardware of functional components to be included in Remote 501a, in an embodiment.

Once Network Interface Device 503a of Remote 501a determines that a particular traffic element is to be forwarded over the downhaul interface, it proceeds to transmission through Wireless Interface function 502a, according to the required Quality of Service requirements for each Backhaul Service Flows.

Circuit data handling: In the particular case of Backhaul Service Flows carrying circuit oriented traffic, Relay 510a will allocate a set of fixed and periodic resources in each wireless frame, where the Remote will transmit and receive as a first priority. Such mechanism is designed to respect the delay sensitive, synchronous and fixed data rate nature of the circuit-oriented traffic by leveraging the synchronous nature of the Point to Multi-Point wireless frame.

Optionally, for circuit-oriented backhaul data, Remote 501a may process data contained in the E1 or T1 slots in order to suppress certain information bits such as padding bits, or to separate certain traffic, such as signaling traffic, in view of transmission over a separate Backhaul Service Flow in the backhaul network. Suppressing certain bits in the backhaul data flows saves bandwidth on the backhaul interface, while separate transmission of certain information allows more flexibility in providing more robust protection to certain information while maximizing the efficiency for the rest of the data (encoded voice, for example, which tends to be less sensitive to transmission errors). More robust protection may be achieved by using redundancy techniques, lower modulation orders or stronger coding techniques, and those can be applied selectively to the information elements requiring stronger error protection.

Backhaul Relay Module (Relay): FIG. 5A represents Relay 510a equipped with three PMP Downhaul Interface functions 511a, 511b and 511c, each responsible for managing a downhaul channel (that may be wireless) as part of a multi-sectored configuration. Different configurations are however possible, with different number of PMP Downhaul Interface Functions, or different sectorization options, and nothing shall be taken in this description as a limitation in this regard.

One skilled in the arts will recognize that the PMP Downhaul Interface, for a wireless downhaul, may be implemented as a combination of a wireless baseband micro-processor configured as a PMP base station, an RF transceiver and one or several antennas.

PMP Downhaul Interface: Each PMP Downhaul Interface, such as 511a controls a plurality of Wireless Downhaul Links 505a, 505b and 505c towards Remotes 501a, 501b and 501c respectively, using a common shared channel. Relay 510a controls those wireless links as part of a point to multipoint wireless interface via PMP Downhaul Interface 511a, and using techniques known in the arts. As such Relay 510a is able to allocate resources and prioritize traffic based on the QoS classes and attributes associated with each Backhaul Service Flow, and taking into account real-time status and values of certain system parameters such as Carrier to Interference and Noise Ratio (CINR), Bit Error Rate, Received Signal Strength, and other Channel Quality Indicators or measurements.

PMP Downhaul Interface 511a is also responsible for selecting various wireless communication parameters such as transmit power, burst size, modulation, forward error coding, polarization or antenna selection; retransmission strategies; admission control and scheduling types. A variety of methods or algorithms can be used, including some well known in the arts. The architecture in the system does however enable the PMP Downhaul Interface Function 511a to implement different methods according to each service flow.

The wireless downhaul interface may operate in a variety of frequency bands, either licensed or unlicensed. Example of such frequency bands include 450 MHz, 700 MHz, 2.0-2.1 GHz, 2.3 GHz, 2.4 GHz, 2.5-2.7 GHz, 3.3-3.4 GHz, 3.4-3.8 GHz, 4.9 GHz, 5.4 GHz, 5.8 GHz, 6 GHz, 10 GHz, 11 GHz, 26-28 GHz and other bands.

As noted earlier, an example of a wireless system that may be used for the downhaul point to multipoint wireless interface is given by the IEEE 802.16 specification. The particularities of this protocol are well suited to an embodiment of the system as they offer the means for a central entity such as a Backhaul Relay Module to control and assign bandwidth and other wireless resources to a plurality of dependent remote units, such as the Backhaul Remote Units.

Scheduling: In the general case, various well known scheduling methods may be used by Relay 510a, depending on the Quality of Service classes and attributes specified for the given Backhaul Service Flows. For instance scheduling techniques specified in the IEEE 802.16 series of standards may be used for this purpose, including those specified for Best Effort (BE), Non Real Time Polling Service (NRTPS), Real Time Polling Service (RTPS), Enhanced Real Time Polling Service (ERTPS) and Unsolicited Grant Service (UGS).

As can be seen, in an embodiment of the system, the Downhaul Interface Function 511a of Relay 510a uses Backhaul Service Flows in order to ensure transmission of backhaul traffic on the downhaul interface while ensuring QoS requirements and maximizing system performance. It does so by also taking into account in real time the measured or reported conditions of each wireless links, as well as the overall system status.

Upon successful reception by the Downhaul Interfaces of Relay 510a, each Backhaul Service Flow will be transmitted to Routing and Relay Function 512, along with any useful control or signaling elements. Routing and Relay Function 512 can thus ensure that QoS requirements such as low latency or minimum data rates are met at this stage of the process, and that adequate QoS requirements are also met on the uphaul interface.

Routing and Relay Function: Relay 510a also includes Routing and Relay Function 512, responsible for relaying Backhaul Service Flows at the MAC layer in order to optimize QoS performance such as latency, jitter, data rates, etc., and for routing them between PMP Downhaul Interfaces functions 511a, 511b, 511c, Uphaul Interface 513, and optional Network Interface Device Function 514.

As an example, Routing and Relay Function 512 will ensure that data on Backhaul Service Flows requiring low latency for synchronous traffic, such as for circuit-oriented data, will be forwarded at fixed intervals in the next available slots in order to minimize latency. Traffic elements using other Backhaul Service Flows may be buffered for later forwarding, according to various schemes, for instance in order to maximize system capacity.

As another example, different routing options may be applied depending on Backhaul Service Flows: this allows flexibility to use layer 3 routing for certain Backhaul Service Flows while using a default route, for instance to the Hub via the uphaul interface for others.

One important characteristic of the Routing and Relay Function is that it may easily be configured or programmed so that a network operator may easily adapt the traffic handling functions to meet its special needs. It will be appreciated that Routing and Relay Function 512 may be implemented as a software process on a highly programmable Network Processor chip, although other implementation options exist and may be used in an embodiment.

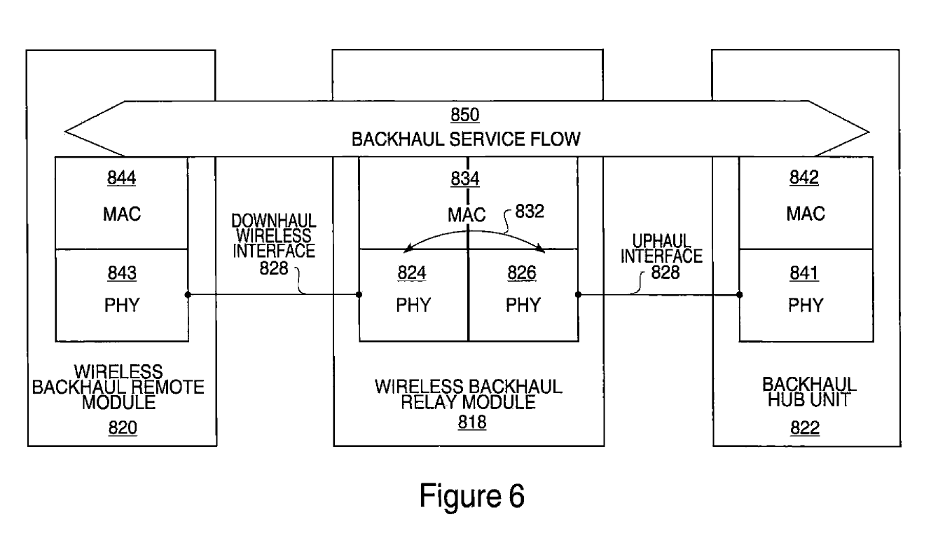

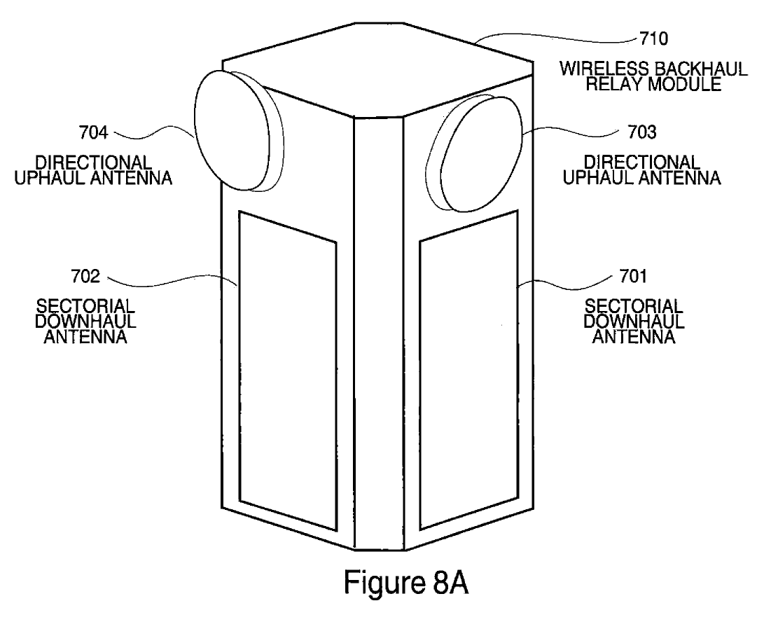

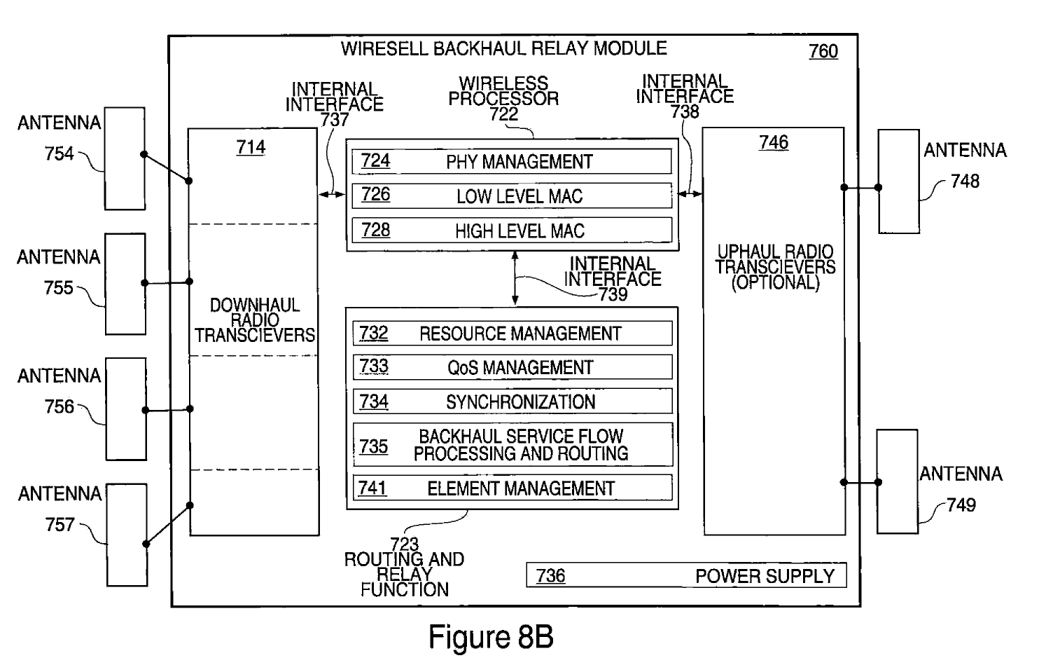

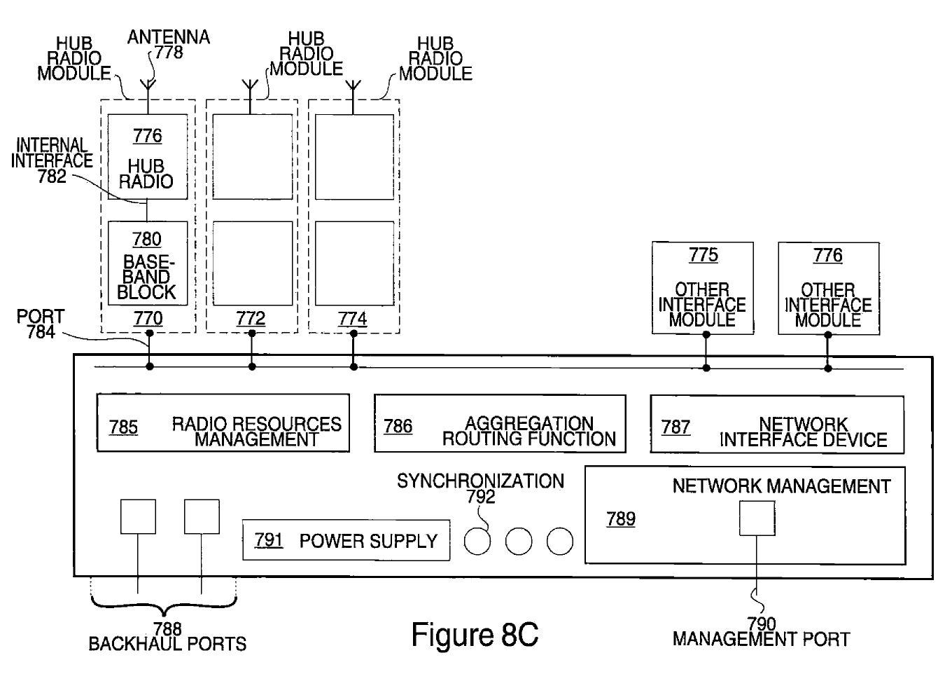

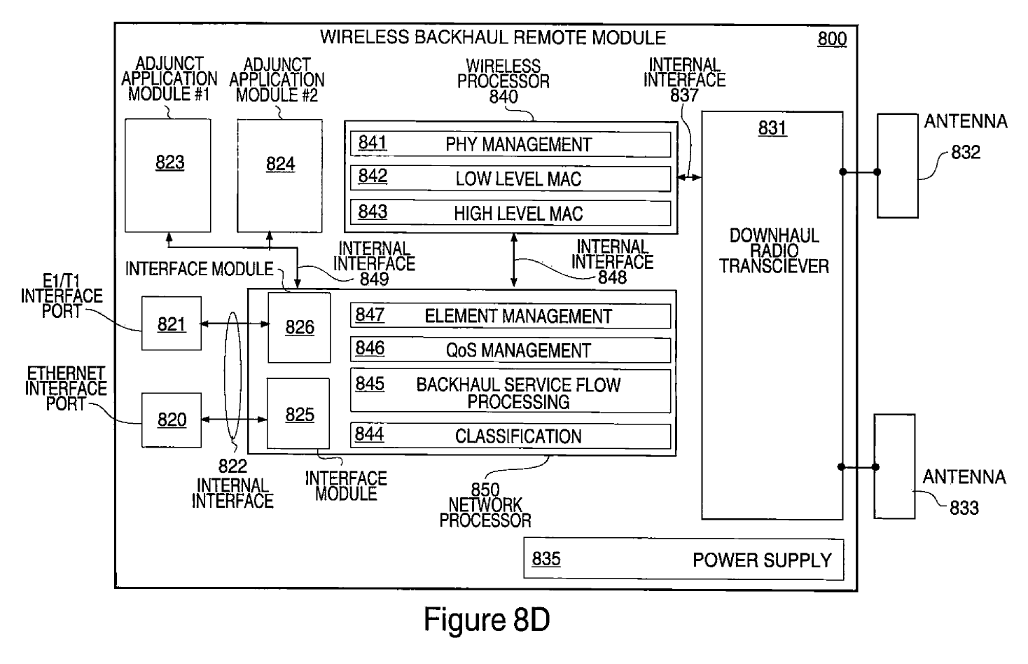

Relay functionality: FIG. 6 shows, in accordance with an embodiment of the system, the protocol stack within a Relay, such as 510a, 510b or 510c of FIG. 5A. In FIG. 8, Relay 818 is employed to connect Remote 820 and to relay information between Remote 820 and Hub 822. Relay 818, Remote 820 and Hub 822 are analogous to Relay 510a, Remote 501a and Hub 520 of FIG. 5A, respectively. It should be noted that although this figure illustrates a Relay communicating with a single remote, the general case of an embodiment would enable a plurality of such remotes to communicate with a single relay.

Furthermore, Relay 818 is shown to include two instances (or sides) of the a protocol stack, which includes PHY layer 824 associated with the downhaul interface, and a PHY layer 826 associated with the uphaul interface. In the case of in-band uphaul, the two instances of the protocol stack are in fact identical. At the MAC layer (layer 2), the relay function is implemented to bridge between one side of the protocol stack (e.g. the downhaul side, facing towards Remote 820) and the other side of the protocol stack (e.g. the uphaul side, facing towards Hub 822). In general, the information transmitted (resp. received) on the uphaul side would be a multiplex of all the information received (resp. transmitted) on the downhaul side. Note that the relay function is implemented as an integral part of the wireless MAC 834. In the case of in-band uphaul, the uphaul link is treated in a manner similar, but not identical to one of the downhaul link.

As a general embodiment of the Relay, the transmission channel is decomposed into several logical sub-channels in the downstream and in the upstream direction. A certain number of those sub-channels are used to carry the traffic originating from or terminating to the Remotes 820 (downhaul channels), and a certain number of those channels are used to carry the traffic to and from the Hub 822 (uphaul channels). The PHY instances (824 and 826) and MAC 834 level implementation for all these channels are handled in similar way by the wireless module's transceiver, such that no modification of the wireless protocol is required. The downstream direction (resp upstream direction) shall denote the traffic originating from (resp. terminating at) Relay 818 towards (resp. from) Remote 820—downstream downhaul (resp. upstream downhaul)—or towards (resp. from) the Hub 822—downstream uphaul (resp. upstream uphaul). Note that the separation between an upstream and a downstream channel may be in the time domain (Time Division Duplex) or in the frequency domain (Frequency Division Duplex) indifferently. The wireless channel may consist of a single frequency channel or of multiple of them.

A multiplexing/demultiplexing function is implemented within Relay 818 in order to aggregate and disaggregate selected traffic to and from Remote 320 (depending on the outcome of the routing decision for the given Backhaul Service Flow 850, for instance). In the case of the upstream downhaul traffic (coming from the Remote 820 to the Relay 318), the aggregated traffic is then presented to the uphaul downstream interface of Relay 318 (going to Hub 822). In the case where only one uphaul channel is available, the aggregated uphaul traffic is sent over this downstream channel. In the case where multiple uphaul channels are available, a special algorithm may be used to distribute the aggregated traffic over these channels. Such algorithm may be based on load sharing, redundancy or diversity schemes so as to maximize uphaul channel capacity, performance and reliability. In the case of traffic received from Hub 322 on the upstream uphaul sub-channels, the uphaul data is received at Relay 318. In the case where only one uphaul channel is available, no particular operation is required to recompose the uphaul data. In the case where multiple uphaul channels exist, a recomposing function is required within the relay function to constitute the complete flow of data to be transmitted towards the access side. This function may invoke voting and/or combining algorithms in order to maximize reliability, performance or capacity of the backhaul channel. The relay function then de-multiplexes the information received on the backhaul interface and uses the downstream channels dedicated to access to carry it to the wireless terminals. The relay function may perform other operations on the data, such as fragmenting or concatenating the data, or applying certain protection to the data, for instance in the form of coding or retransmission, in addition to the multiplexing and demultiplexing operations. Note that in the case where the wireless channel consists of more than one frequency carrier, the backhaul traffic may be carried on a separate frequency channel than the access traffic by using an embodiment.

It is important to note that in the particular case of an embodiment using in-band uphaul, even though the backhaul and access channels are implemented in a similar way, Relay 318 may allocate different parameters in a static or dynamic way to each of the individual channels. For instance, special algorithms may be employed on the uphaul interface in order to optimize the performance of these channels by taking advantage of the specific nature of the uphaul links and traffic. Since the system manages both the downhaul and uphaul resources, it is also able to dynamically alter the amount of resources allocated to the downhaul and uphaul channels in the upstream and downstream directions. This dynamic resource allocation may be performed as a function of traffic characteristics or link conditions or performance metrics, so as to maximize overall system performance and capacity or to maximize performance of certain traffic flows.

In a particular embodiment of the system when an in-band uphaul method is used, the wireless interface can use a time division multiplex whereby all individual wireless links share the wireless medium at different time intervals as scheduled by Relay 318. In this embodiment, the downhaul channels shall use one particular set of time divisions in the transmit and in the receive direction and the uphaul channels shall use another set of time division channels in the transmit and the receive direction and Relay 318 shall manage the allocation of the time resources between downhaul and uphaul channels.

In another embodiment of the system, the wireless interface can use a frequency division multiplex whereby the various Remotes shall use one or many sub-channels. In this embodiment, the Downhaul channels shall use one particular set of frequency domain sub-channels in the transmit and in the receive direction and the uphaul channels shall use another set of frequency domain sub-channels in the transmit and the receive direction and Relay 318 shall manage the allocation of the sub-channel resources between downhaul and uphaul channels. A particular example of this case would be for an orthogonal frequency domain multiple access (OFDMA) system.

In yet another embodiment of the system, the wireless interface can be structured according to a two-dimensional time and frequency domain division. In this embodiment, the relay function may implement the downhaul and uphaul channels as any combination of frequency sub-channels and time domain division. Note that this case encompasses both of the previous cases.

Other embodiments of the system may involve code division in order to define the downhaul and uphaul channels, or a combination of any of the above with code division multiplexing.

Among the benefits of an embodiment of the relay function, is the fact that the relay function can access and control various resources according to parameters pertaining to the radio environment, the quality of service, packet handling, and the like, and can control traffic with information obtained at the MAC level 834 and above. It should be noted that in the case of in-band uphaul, although the data transferred on the downhaul side and on the uphaul side are similar, the relay function may modify any of the transmission parameters used to carry this data between the two sides. For instance, the link parameters used to carry information from remote 820 to Relay 318 may be optimized according to the nature of these particular links, and the link parameters used to carry the same information on the link to hub 822 may be different in order to reflect the optimal use of the resource on the uphaul interface.

Another important aspect of the Relay implementation is that it does not require any changes to the wireless protocol in order to perform the relay function. As an example, the IEEE 802.16 protocol (also known as WiMAX) may be used as the wireless downhaul protocol, and this same protocol may be used to implement the uphaul link towards the Hub 822, particularly in the case of inband uphaul. This is important in those cases. In this embodiment of the system, the relay function would terminate the protocol on each of the downhaul links, process them as per the rules of Backhaul Service Flow 850, then multiplex the traffic on all links required to be transmitted on the uphaul interface at a particular instant, and convey the information on the uphaul link using the same protocol, but in an anti-symmetric manner (i.e. the received information being transmitted and the received information being transmitted). It should be noted however that nothing precludes an embodiment whereby non-standard enhancements to the wireless protocol are implemented in order to optimize the performance or efficiency of the uphaul link for instance. Such enhancement may include using higher order modulations, and specific coding or subchannelization schemes, or particular antenna or diversity techniques. Preserving the integrity of the wireless protocol is necessary in those cases where a standard wireless protocol may be required for interoperability purposes, particularly on downhaul interface 828 towards remote 820.

An embodiment allows multiplexing to be done according to a variety of methods and algorithms that may take into account such parameters as Quality of Service (QoS) attributes for each data flows, or traffic and network loading statistics.

An embodiment allows transmission parameters such as transmit power levels, frequency channels or subchannels, channel bandwidth, modulation, forward error correction, burst size, segmentation, spatial or polarization diversity, retransmission policies to be different and independent on the downhaul links and the uphaul links. An embodiment of the system may for example optimize the value of these parameters independently on each of those links, within the limits and rules of the protocol used on both interfaces. Note that even though the system allows the use of the same standard protocol on the downhaul and uphaul sides, nothing precludes a particular embodiment where one of the links (for instance one of the uphaul links) would use different, non-standard parameters as compared to the downhaul links.

It should be noted that the relay mechanisms described hereabove may be used in a variety of configurations in addition to the backhaul scenario forming the main part of this description. For instance, one particular embodiment can use the relay mechanism described hereabove for a network designed to provide access to mobile terminals directly. In this case the Relay unit acts as a base station with integrated backhaul, with the downhaul interface providing the wireless interface to a plurality of mobile terminals such as handsets, mobile phones or mobile data terminals or computers. Such a configuration has the benefit of lower costs since the base station integrates its own backhaul.

Uphaul Interface: Returning to FIG. 5A, Relay 510a includes an Uphaul Interface 513 (that may be wireless), responsible for transmitting the aggregated uphaul traffic to and from Hub 520, either directly or via a series of hops involving other Relays, as illustrated by 510b and 510c (for instance in case an alternate uphaul link is used). It will be appreciated that such function can be implemented as a baseband processor responsible for managing the physical and low level MAC layer functions of the wireless interface, coupled with at least one RF transceiver and one or several antenna(s). The frequency bands that may be used for the uphaul wireless interface in an embodiment may be any of those available for the downhaul interface, or higher frequency bands such as 40, 60 or 80 GHz in order to deliver a higher throughput as required to transmit the aggregate of all backhaul flows.

When transmitting over the uphaul interface, Uphaul Interface 513 uses the Backhaul Service Flow identifier assigned by one of the Network Interface Device Functions within the backhaul network, in order to maintain end-to-end context and QoS. In particular, Uphaul Interface 513 uses this information in order to manage its QoS and transmission parameters accordingly.

In an embodiment, Uphaul Interface 513 may use virtual connections of its own in order to differentiate between different QoS or handling requirements. Such virtual connections may be called Uphaul Service Flows. The Uphaul Interface Function 513 may thus group multiple Backhaul Service Flows with similar QoS attributes on a single Uphaul Service Flow. This is particularly useful in the optional case of inband uphaul.

The Uphaul Interface 513 may use similar scheduling and transmission mechanisms as on the downhaul interface. A general embodiment however will only require one Hub Unit, and therefore this connection can be considered as a point to point connection.

In another embodiment of the current system, the Uphaul interface may be part of a Point to Multipoint system where the controlling entity is within the Hub. This generalizes the point to point case previously described.

External Backhaul Interface: Relay 510a may optionally backhaul its uphaul traffic with an external device or facility (such as a fiber connection) connected through Network Interface Device 514. In this case, Network Interface Device 514 fulfils the same functions as other Network Interface Devices 503 and 523 previously described and Routing and Relay Function 512 decides which information elements are transmitted via this interface, and how. For instance, use of the external interface may be decided statically through configuration, or dynamically on a load sharing basis, or a redundancy basis.

In another particular embodiment of the system, a Relay may be connected directly to a traffic source or sink such as a cellular base station via Network Interface Device 514. Routing and Relay Function 512 will handle the backhaul traffic from 514 as if it was received from one of the PMP Downhaul Interfaces.

Backhaul Hub Unit (Hub): In an embodiment, a Backhaul Hub Unit such as 520 is responsible for terminating the uphaul interface thanks to Uphaul Interface 521a, for aggregating and routing backhaul traffic flows coming from a plurality of Uphaul Interfaces, and for managing the interface to an external backhaul port via Network Interface Device Function 523. Several configurations of Hubs may exist, ranging from one configuration with only one uphaul interface (which may be referred to as a mini-hub), to configurations combining several dozens of uphaul interfaces. In the later case, such uphaul interfaces may be arranged as a plurality of directional wireless links, with high gain directional antennas, or as a sectored configuration wherein one or a plurality of wireless uphaul interfaces connects to one sectorized antenna, and the process repeated with several sectorized antennas.

In an embodiment, Uphaul Interface 521 may be implemented as a single outdoor unit consisting of baseband processing and network processing functions, RF transceivers and antenna ports or integrated antenna. In the case of a mini-hub, such single outdoor unit may also include Aggregation and Routing Unit 522 and Network Interface Device 523 that may both be implemented in circuitry. Circuitry in this description can be a piece of hardware circuitry; hardware logic, or software running on a processing circuit or functions programmed and executed by a processor. It can be noted that in this case, a mini-hub shares the common architecture of a Remote, and as such may be implemented on the same hardware platform and share many of the software code. Specific hardware and software components are however required for providing an external timing reference to the Hub since it is responsible for providing timing synchronization to the rest of the network.

In the general case of a Hub with a plurality of Uphaul Interfaces, Aggregation and Routing unit 522 and Network Interface Device 523 may be implemented as part of a separate indoor or outdoor unit, referred to as “Aggregation Unit”. In this case, Uphaul Interface units may connect to the Aggregation Unit via Ethernet cables carrying both signal and power (Power over Ethernet), as well as synchronization signals. Physical implementation of the Aggregation Unit may be similar to a conventional router with processing logic to handle the various functions as described in the rest of this description.

Once Hub 520 receives data on uphaul link 516a and interface 521a it presents the data elements to the Backhaul Aggregation and Routing unit 522 which can be implemented as a router within Hub 520. This function may route the data either towards another Relay, or on its backhaul interface, 524, via the Network Interface Device 523, depending on the routing analysis.

In an embodiment, Hub 520 also integrates a Network Interface Device 523, in order to perform similar functions based on the traffic received from or transmitted towards the core network, 524. The role of this Network Interface Device is therefore similar to that included in the Remotes. Similarly the Network Interface Device within the Hub is capable of transmitting signaling information containing indications of the differentiated nature of particular traffic elements towards a Relay through Uphaul Interfaces 521a, 521b and 521c and Uphaul Links 516a, 516b and 516c.

Network configuration and set-up: The above paragraphs describe the backhaul process using the various network modules and their functional components. The following paragraphs describe how each module is configured, provisioned and set-up for operation.

FIG. 5B represents the network management structure associated with an embodiment of the system. Configuration Servers 551 includes a repository of all addressing information, for instance as in the case of a DHCP server, and a configuration file repository with all configuration information for each network element. Such configuration file are created and formatted by the network operator and uploaded to a server such as a TFTP server. Among other parameters, configuration files include all classifier and Backhaul Service Flow information pertaining to the Remotes, Relays and Hubs within the backhaul network. Configuration Server 551 connects to all the network elements in the backhaul network via Data Network 552. The network elements in this context include Backhaul Hub Units such as 553, Relays such as 561, 562 and 563, and Remotes such as 571 to 579.

It will be recognized that protocols and platforms well known in the arts may be used to implement this network management architecture, allowing remote provisioning of a plurality of network elements. As such, such an architecture applied to the backhaul system implemented as an embodiment of the system offers a standardized method for remote management and provisioning of the entire network.

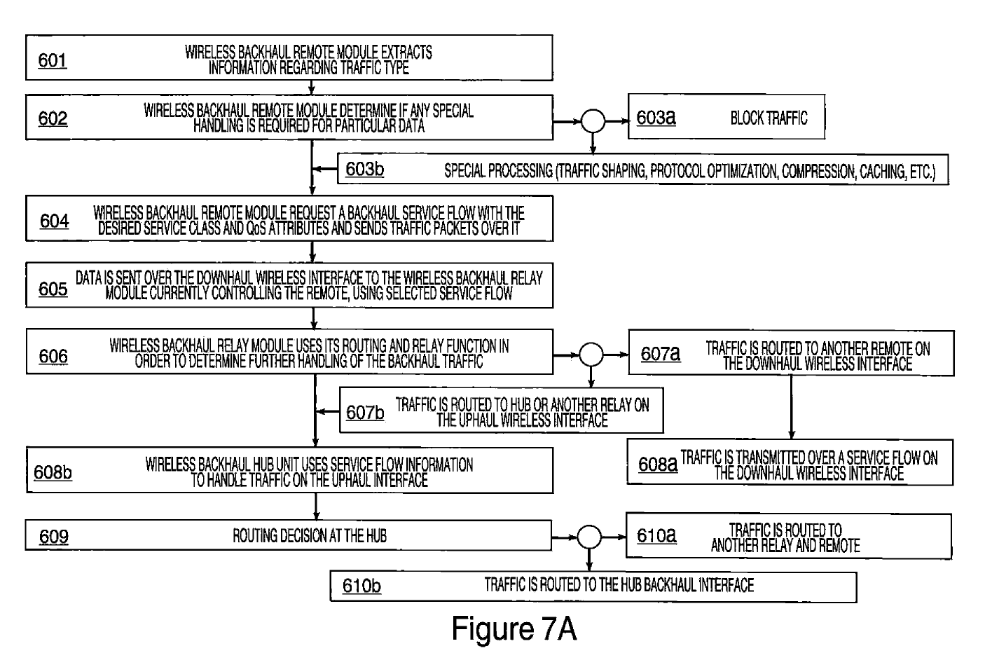

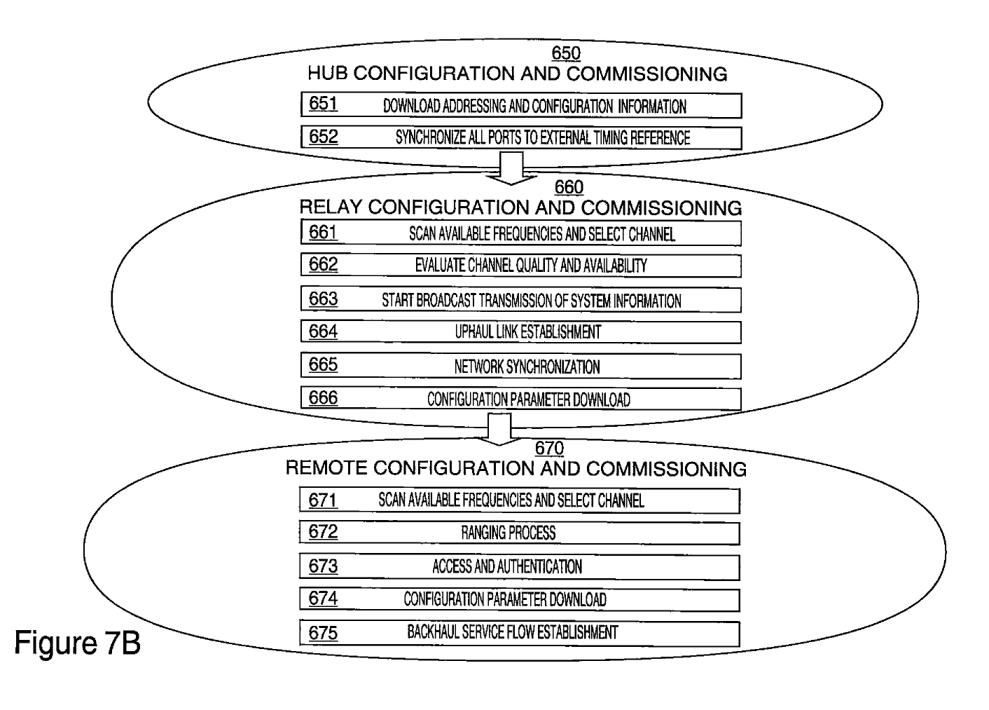

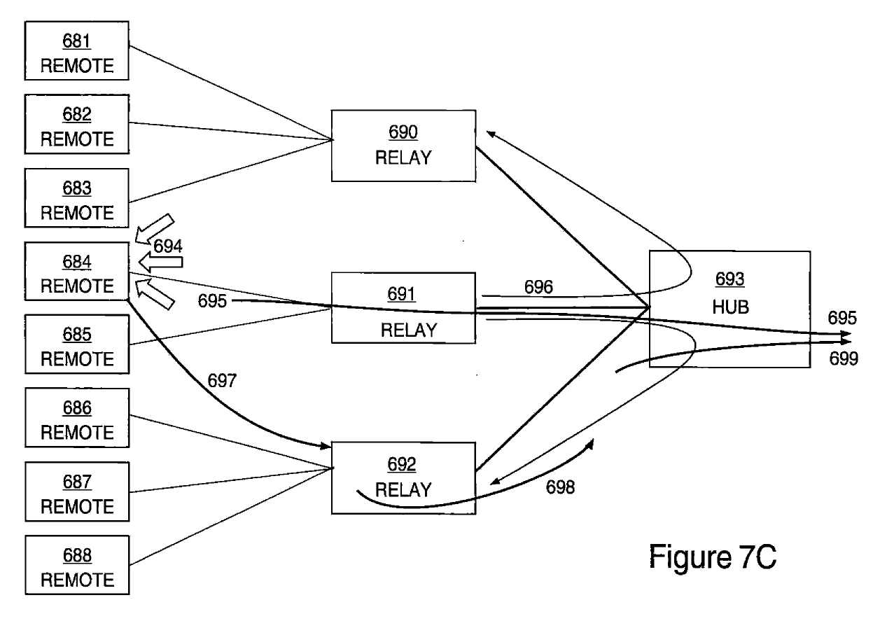

Backhaul transmission process: FIG. 7A provides an example of how differentiated classes of services are provided by an embodiment of the system. In a first operation, 601, the Network Interface Device Function within a Remote determines the type of application or user by analyzing the backhaul traffic flows, and assigns it to a pre-established Backhaul Service Flow (classification).

In step 602, the Network Interface Device within the Remote determines if any special treatment is required for data element on this particular Backhaul Service Flow. Particular treatments may include blocking the data traffic as in 603a, buffering, or applying a particular processing to the data before being transmitted as in 603b, as may be required by the network operator. Examples of particular processing include protocol optimization, compression, caching, and other known in the arts. By default, the information element is scheduled to be transmitted on the downhaul wireless interface on the given Backhaul Service Flow.

In step 604, the Remote requests bandwidth for transmission on the Downhaul channel using parameters associated with the pre-established Backhaul Service Flow, such as latency requirements, minimal data rate requirements, packet loss requirements or any other quality of service attributes, according to the type of data or application as determined in step 601, and assigns the traffic data elements to it. Any other information relevant to the end-to-end processing of the backhaul traffic, as may be required by the Relay or the Hub may also be sent to the Relay. The data is then sent to the Wireless Interface function of the Remote for transmission on the downhaul interface, under the control of the Relay.

In step 605, the data element or packet is sent over the downhaul wireless interface towards the serving Relay. The Relay may use a range of scheduling and bandwidth management techniques in order to guarantee the service levels of the selected Backhaul Service Flow, and to maximize resource usage. The data is then forwarded to the Routing and Relay Function within the Relay, which determines whether to route the data to another Remote using the downhaul wireless interface as in 607a and 608a, or to transmit it towards a Hub on the uphaul interface as in 607b, or to apply any other handling to the data.

By default, in 608b, the Relay transmits data and control information, including the Backhaul Service Flow index, as part of an aggregated traffic flow on the uphaul interface, including backhaul traffic from all Remotes connected to it and sharing the same Backhaul Service Flow characteristics, plus possibly data coming from other Relays to which it may be connected, also associated with the same Backhaul Service Flow characteristics.

Finally, in 609, the Hub uses its aggregation and routing function to analyze the incoming data and determines what actions to take, including possibly routing certain data flows towards other Remotes via a Relay as in 610a, or, by default, routing traffic towards its backhaul interface, through its Network Interface Device as in 610b. In the case of 610a, the Backhaul Service Flow information provided over the uphaul interface by the Relay may be used to ensure end to end service levels throughout the system, in a symmetrical way to that used for transmission from the remote to the hub. In the case of 610b, the Backhaul Service Flow information may be used by the Network Interface Device to map to certain external protocol element which may be used on the Hub's backhaul interface. It should be noted that the Backhaul Service Flow index is no longer required after the hub successfully handles the backhaul traffic, and thus it is not transmitted on the backhaul interface.

FIG. 7B illustrates the setup process for all network element in an embodiment of the system. The setup process generally starts with commissioning a particular Hub unit as shown in 650. This is done by using the information stored in the addressing and configuration servers using methods and techniques well known in the arts, as shown in 651. Since the Hub may be connected to an external timing reference in order to provide synchronization to the rest of the network, the hub will use this timing reference as part of its initialization process, as shown in 652. It should be noted that initialization of the Hub's uphaul interface requires that a Relay be initialized prior to it, in order to establish connection.

Once a particular Hub is operational, all Relays connected to it may be commissioned and set up as shown in 660. This process includes the Relay being powered up and starting to scan for available frequencies and selecting one channel (661), then evaluating its availability and quality by using processes known in the art (662), then starting broadcast transmission of system information on this channel, for instance by broadcasting the frame structure specified in the IEEE 802.16 specifications (663). Evaluating the quality of the channel at this initial stage is necessary in order to avoid interference with other parts of the network which may be in operation at this time of installation. The Relay then proceeds to establish an uphaul link using its Uphaul Interface Function (664). This process may involve either out-of-band uphaul or inband uphaul depending on the Relay's configuration options and it may be done automatically if a Hub is already activated and the Relay is able to connect to it. In the particular case of an embodiment using inband uphaul, this process is similar to establishing communication to a remote unit using the standard IEEE 802.16 protocol and data elements.

Once the uphaul link established, the Relay initiates a synchronization adjustment procedure with the Hub in order to synchronize to the network-wide timing reference (665). The Relay then downloads configuration files from the configuration server, in order to get configuration parameters and to continue its initialization process accordingly (666).

Once a Relay is initialized, Remotes may be connected to the network and appropriately configured as shown in 670. This is achieved as per the standard processes as defined for instance in the IEEE 802.16 standard, including scanning RF channels (671), using the ranging process to access the channel (672), authentication (673) and downloading of configuration files (674). The Remote may then establish all Backhaul Service Flows it is configured to handle via the Relay (675), which will also trigger establishment of the Backhaul Service Flow from end to end throughout the system. This may be realized using the standard 802.16 processes for establishing virtual connections, with all additional parameters sent as additional protocol elements.

It should be appreciated that installation of the Remotes can be simplified and in fact made automatic by the use of techniques well known in the art, allowing an endpoint in a Point to Multi-Point system to select a best channel and thus a Relay among a list of allowed channels. Signal quality indicators such as received power, signal to noise and interference ratios or other indicators may be used to determine quality of a channel prior to establishing communication. As such, this dispenses the installer from configuring the Remotes at the time of installation. Parameters that may be automatically selected with this method include frequency center channel, channel bandwidth and other RF parameters that may be used by the particular standard. The same mechanism may be used in case of degradation or loss of signal from a Relay in order to reselect another Relay, as described in more details below. While automatic provisioning is a possible scenario, an embodiment may allow an operator to manually configure a Remote or a Relay.

Redundancy: In certain cases, it may be required that the system provide redundancy in order to ensure end-to-end resiliency within the backhaul network, or to respond to network overloading conditions. Methods are described hereunder for redundancy management on both the downhaul or on the uphaul links.

In an embodiment, each of the Relays, 510a and 510b implements a mechanism allowing any of the Remotes under its control, 501a, 501b and 501c (in the case of 510a) to re-tune its wireless interface unit 502a, 502b or 502c, respectively to a different channel controlled by 510b or other Relay. Note that two Relays may be co-located and use distinct and non overlapping RF channels as part of a 1:1 redundant configuration. A more general case, however, is when the old and the new relays are located in different sites. Prior to a switchover, the Remotes will periodically measure a number of different channels in order to assess the quality of that channel and report it to the corresponding Relay 510a. This mechanism is done in coordination between Relays 510a and 510b, for instance via Hub 520.

In a particular embodiment, a standard handoff mechanism, as defined in the mobile wireless standard defined in the IEEE 802.16 specification may be used in order to implement this mechanism. As part of the switchover operation, the initial Relay may transfer information to the target Relay in order to prepare the target relay to communicate with the Remotes previously connected to the original Relay. Such information may include a list of all established Backhaul Service Flows and their characteristics.

FIG. 7C illustrates an example of the redundancy process as part of an embodiment. In such a mechanism, a particular Remote such as Remote 684 may be programmed or instructed to monitor both the current channel used to communicate with the serving Relay 691 (that is the Relay with which the particular Remote is currently communicating with via the downhaul wireless interface), and other channels corresponding to neighboring Relays 690 and 692, as illustrated in step 694. In an embodiment, this monitoring process may be periodical or punctual, based on implementation options. The list of other channels to monitor can be determined either based on a static configuration parameter, or by explicit action from a network operator, or automatically based on certain criteria established either by the Relay, or by the Hub. A Remote may then constitute a list of Relay units (which may be designated as “backup relay list”) and RF channels that may be used in case a switchover is required and this list may be provided to the serving Relay (695).

The serving Relay may use the backup relay list provided by each Remote under its control to inform certain neighboring Relays of Remotes that may access in case a redundancy action is invoked (696). This information may be sent to the Hub for similar purposes. The serving Relay may also send additional information along with this list. Alternatively, the neighboring Relays or the Hub may be able to get the Backhaul Service Flow information by querying the configuration server holding the information. Each Relay or Hub receiving this information may thus get configuration information for each remote that may be attempting to connect to it. In particular the list of active Backhaul Service Flows for each Remote can be downloaded from the configuration server.

The neighboring Relays thus have all information to manage their status and resources in order to prepare for being accessed by one or a plurality of Remotes, as may be triggered by a failure of their serving Relays or other failures in their backhaul network. For instance, a neighboring Relay may decide to reserve some capacity (for instance in the form of fixed data bursts within the downhaul and possibly uphaul wireless frames) for certain of the delay sensitive and high priority Backhaul Service Flows for a given number of Remotes. Some additional capacity may be reserved for other non-critical applications using lower priority Backhaul Service Flows. In addition, the neighboring relay may allocate reserve capacity on the Uphaul interface to ensure that it will be ready to accommodate the additional load generated by new Remotes accessing this particular Relay. As such, a neighboring Relay can be prepared to take over the traffic from one or a plurality if Remotes previously served by the serving Relay, and to minimize the interruption time. In a similar way, a Hub may prepare for a redundancy event by using the data provided to it periodically by the Relays. Network operators may thus engineer the network in order to achieve a certain level of availability, while maximizing the use of the network resources.

A redundancy switchover is the process by which a Remote will connect to a new Relay due to a network failure or due to an explicit network indication. As such, the Remote may initiate switchover if it cannot maintain a connection with the Serving Relay with sufficient quality. In that case, the Remote will switch its channel and possibly other transmission parameters such as antenna configuration and parameters, in order to connect to a new Relay, the Target Relay (697). In order to achieve link establishment with the Target Relay, the Remote uses the standard network access and ranging process as described for the particular wireless standard used to implement the downhaul interface. Since the Remote will have monitored the condition of the link and may have already received some of the parameters allowing it to access the Target Relay, establishment of the new link may be reduced.

A Serving Relay may also initiate a redundancy switchover by directing some or all of the Remotes under its control to change their serving Relay and channel. This may be done by sending messaging indications to some or all of the Remotes to initiate the switchover sequence. Upon receiving this message, the affected Remotes will start the switchover process as described previously.

Upon accessing the new Relay, a Remote will re-establish each Backhaul Service Flow in order to allow transmission of all backhaul information as it was done previously. The Relay is able to recognize those Backhaul Service Flows thanks to the information received previously, and thus can re-establish the downhaul connection as well as the uphaul connection in a minimum amount of time, resulting in minimal service disruption (698).

Several cases may exist, depending on whether the new channel to which the Remote connects to belongs to the same physical Relay unit, or to a different one. In the first case, the Relay can handle the switchover operation without changing the configuration of its uphaul link. In the case where the switchover operation involves another Relay, the uphaul connection used to backhaul traffic from the Remote will be changed and thus, the Hub unit will recover the traffic according to each Backhaul Service Flows, and it will be able to process the backhaul traffic and, for instance, transmit it on its own backhaul port (699).

It should be noted that variations may exist in the method and protocols for accessing a new Relay, depending on the wireless standard or protocol in use on the downhaul interface. The intention of this description is to specify the network mechanisms which are largely independent of these protocols. Similarly on the uphaul interface, several mechanisms may be used to re-establish a uphaul connection towards a wireless hub, depending on the type of interface.

Since the Remotes can be instructed to constantly monitor one or many surrounding downhaul channels, and since a secondary Relay may be prepared to accept the traffic to and from this particular Remote, a re-configuration of the backhaul network can be accomplished within a few frames, thus allowing minimal service disruption (typically less than a few frames or 10 ms). In addition, any data elements lost, duplicated or received out of sequence as a consequence of the change-over process may be handled at Hub 520.

A similar mechanism may also be employed on the uphaul link in an embodiment. In a particular embodiment, the Relay may keep a list of possible backup channels for the uphaul. Those channels may connect to the same Hub, a different Hub or another Relay. In the later case, transmission through another antenna pointed towards the alternate Relay may be necessary. Upon detecting a failure condition on the uphaul link, the Relay may decide to initiate a change of the uphaul link channel or antenna. This may be done by pre-establishing a second connection and then switching the channel to the new connection. In the case where the backup channel belongs to the same Hub, it is able to re-route the traffic towards the general backhaul interface through Network Interface Device 524.

Wireless Backhaul Remote Implementation: FIG. 8D represents an example of a Backhaul Remote Module as part of an embodiment of the system using a wireless downhaul interface. Remote 800 consists of an enclosure containing power supplies 835, electronics, radio equipments and external antennas 832 and 833. In a particular embodiment, this enclosure may be a standalone unit designed for outdoor installation. In an alternate embodiment, a remote may be optimized for indoor installation.

Remote 800 provides two external interface ports, 820 for Time Division Multiplex traffic conforming to either E1 or T1 standards, and 821 for Ethernet traffic, for instance for full duplex data rates of up to 100 Mbps. These interface ports connect to interface modules 825 and 826 within a Network Processor unit 850 inside Remote 800 via internal interfaces 822, for instance a high speed digital bus. These interface modules format the data on those two interfaces into a common format for processing by Network Processor 850.

Network Processor 850 implements a number of logical functions, such as Classification 844, Backhaul Service Flow Handling 845, QoS Management 846, as explained in the description to FIG. 5. In addition, Element Management 847 provides all the functions required for management of the Remote within the network and for collecting and providing management information to an external management or configuration server.

Wireless Processor 840 implements all the functions required for transmitting and receiving on the Downhaul Interface, when a wireless medium is used for this interface. Note that an alternative embodiment may use another medium such as a wireline interface in order to implement this function, in which case a similar processor specialized for this medium would be used to implement this interface. Wireless Processor 840 connects to Network Processor 850 via Internal Interface 848 and implements all physical layer (PHY), 841, as well as lower level Medium Access Control (MAC) 842 or upper level MAC functions 843. Note that other implementations may exist than this descriptive example, whereby for example the above functions or parts thereof may be implemented on a separate processor such as Network Processor 850, or all integrated on a single processor.

In the case of a wireless downhaul interface, Wireless Processor 840 connects to a Radio Transceiver 831 designed to operate in the range of frequencies chosen for the downhaul interface, via internal interface 837. In a particular embodiment, Radio Transceiver 837 may be integrated as part of Wireless Processor 840 in order to reduce cost, power consumption and size of the Remote Module. In another embodiment, several radios may be used in order for example to implement a diversity scheme or a beamforming mechanism. Radio Transceiver 837 connects to one or a plurality of antennas 832 and 833 in order to radiate the radio signal as generated. In an example, an array of antennas may be used in order either to implement a Spatial or Polarization Diversity scheme or a Multiple Input Multiple Output scheme designed to increase link availability, capacity and range on the downhaul interface, or to implement a beamforming mechanism designed to increase antenna gain according to a set of particular directions and to minimize interference from other directions. In yet another example, directional antennas may be used in order to provide a high gain in a particular direction. In yet another example, omni-directional antennas may be used in order to facilitate installation procedures and to connect to any Relays in the vicinity of the remote.

Adjunct Application Modules #1 and #2, 823 and 824 are independent processors or devices that may be invoked by the Remote in order to provide certain applications. Those modules are meant as factory installable or field installable modules to enhance the functionalities of a Remote. Examples of such modules may include transcoders, or an integrated pico base station. Those modules connect to the Network Processor and its functions via internal interface 849.

Backhaul Relay Implementation: FIG. 8A represents an example of a Backhaul Relay Module as part of an embodiment of the system using a wireless downhaul interface and a wireless uphaul interface. Relay 710 consists of an enclosure containing power supplies, electronics and radio equipment and external antennas, including one or a plurality of antennas, 701 and 702, acting as downhaul multipoint interfaces, and one or a plurality of uphaul antennas, 703 and 704. In a particular embodiment, this enclosure may be a standalone unit designed for outdoor installation. In an alternate embodiment, a relay may be optimized for indoor installation. In this example, the downhaul antennas are sectorial antennas designed to cover 90 degree sectors over a certain distance; and the uphaul antennas are directional high gain antennas designed to be aligned with and to connect to a backhaul termination point, for instance as part of a Backhaul Hub Unit, or another Relay. Note that the directional links and the sector antennas are not necessarily aligned. Such equipment integrates all aspects of a backhaul equipment and as such only requires a power supply to function.

Antenna configurations for the Relay depend on its configuration and required characteristics. In the case of a single channel device using in-band uphauling, a single omnidirectional antenna may suffice. Another possible configuration is a multi-sectored relay module, consisting of four independent wireless downhaul channels arranged each at 90 degree angles and using 90 degree sectorial antennas. In the case where in-band uphaul is used in such configuration, the same antenna may be used for the uphaul. In the case where out of band uphaul is used, a separate antenna or set of antennas may be required. In the case where redundant backhaul links are required for out-band backhaul, two separate uphaul antennas may be required. In yet another example, an embodiment may use beam-forming techniques in order to concentrate the antenna beam towards one particular direction with the possibility of changing the direction automatically or by operator command. In yet another example, several antennas may be used for each channel or sector, for instance to implement a Spatial Diversity scheme, a Polarization Diversity scheme, or a Multiple Input Multiple Output scheme using techniques known in the art, and designed to enhance the downhaul interface's reliability, range and capacity.

FIG. 8B shows, in accordance with an embodiment of the system, the Backhaul Relay Module 760 equipped with a wireless downhaul interface and a wireless uphaul interface. This simplified description does not include an external interface nor a Network Interface Device corresponding to block 514 in FIG. 5A, for clarity purpose. It will be clear to one skilled in the arts, that such a function may be added to the description of FIG. 8B in a simple way, using internal interfaces.

In the example of FIG. 8B, there are shown a plurality of antenna 754, 756, and 758 representing Downhaul antennae for communicating with a plurality of Remotes. Antenna 754, 756, and 758 receive and transmit signals of Downhaul Radio Transceiver 714 representing a point-to-multipoint transceiver circuit to provide RF signal to the antennae. The communication path on the uphaul interface to a Hub may be accomplished via an antenna 757, which in the case of in-band uphaul, is also coupled to downhaul radio 714. In this case, the access antennae 754, 755, and 756 share access radio resource with uphaul antenna 757. Thus, in this case, only a single set of downhaul radio transceiver is required, resulting in significant cost savings since not only the equipment is less costly, but this does not require additional frequency carriers in order to provide uphaul. Power supply 736 provides power to the various components of the Relay.

Alternatively, in the case of out-of-band uphaul, a separate uphaul radio subsystem 746 may be provided to control one or more antennae (shown as antennae 748 and 749) for communication with the Hub. By using two separate radio subsystems (e.g. 714 and 746), bandwidth for the downhaul side and the uphaul side are kept independent. Compared to the previous example, the benefits are that more bandwidth is available on both the downhaul and uphaul side of the system.

In an embodiment using the in-band uphaul option, a wireless base band processor 722 implements both sides of the protocol stack or represents both sides of the protocol stack, i.e., the device side protocol stack and the backhaul/relay side of the protocol stack in the wireless access remote module. In the case of an embodiment using out-of-band uphaul, separate base band processors may be used, or a single one performing the functions of two wireless channels may also be used as implementation options.

Wireless base band processor 722 is shown having at least three separate functional blocks: PHY management 724, low-level MAC management 726, and high-level MAC management 728. Low-level PHY management 724 is employed to modulate and encode the signal before the signal is sent to downhaul radio 714 or uphaul radio 746. Wireless base band processor 722 communicates with downhaul radio 714 or uphaul radio 746 via internal interfaces 737 and 738. Low-level MAC management 726 manages aspects of the signal, such as burst management, framing, multiple access control, ranging, power management, and the like, according to the wireless interface standard specification and particular implementation using mechanisms well known in the arts. High-level MAC module 728 implements among other things resource allocation, QoS management and scheduling, according to the wireless interface standard specification and particular implementation using mechanisms well known in the arts. Resource allocation refers to the allocation of wireless resources, such as bandwidth, to different users, different applications, and the like that are executed on one or more of the wireless devices. The scheduling function of high-level MAC module 728 allocates, for example, packets to different users in a point-to-multipoint environment. The modules of wireless base band processor 722 are only representative and other modules may also be present, or some of the modules of this processor may also be implemented on external processors (for instance in the case of High Level MAC 728, which may be implemented on a network processor, for example on the same platform as Routing and Relay Function 723). Wireless base band processor 438 may be obtained from a variety of commercially available sources and uses standard wireless protocols and will not be discussed in greater detail herein.

A Routing and Relay unit 723 (as shown in FIG. 5A as block 512) is shown, including at least three modules: resource management module 732, QoS coordination module 733, synchronization management 734, and Backhaul Service Flow and Routing 735. Resource management module 732 controls the allocation of wireless resources in the system. These wireless resources may include, for example, sub-carriers, timeslots, antenna arrays, polarization values, etc. Routing and Relay Function 723 relays data bursts between the wireless downhaul side of Relay 760 (towards the Remotes) and the uphaul side of Relay 760 (towards one or several Hubs).

QoS coordination block 733 coordinates QoS between the device side (access) and the backhaul/relay side of Relay 760. QoS coordinator module 733 does so by taking into account QoS requirements from different applications and users whose traffic is being backhauled, which different applications and different users may have different QoS requirements, as well as QoS configuration information, which may be based on the system's configuration files. Furthermore, QoS coordination module 733 ensures that the QoS requirements are met if the user or the application has sufficiently high QoS authorization. At the MAC layer level, this QoS information is available to Routing and Relay function 730 to enable Routing and Relay function 730 to ascertain the QoS requirement of a particular data stream. While the data transfer or core is in progress, QoS coordinator block 733, operating at the MAC layer, has access to Backhaul Service Flow information and can ascertain as well as control the QoS parameters of these packets in order to ensure that the data streams associated with those packets are optimized for efficiency as well as for QoS, and that the channel resources are allocated appropriately. In an embodiment, the Relay notes the Backhaul Service Flow information and employs these parameters to prioritize and allocate resources on both downhaul and uphaul interfaces in order to meet the QoS requirements from end to end.

A synchronization management unit 734 synchronizes the wireless base band processor unit 722 with the rest of the wireless network. Inter-node synchronization is a requirement for many wireless standards in order to mitigate interference and facilitate handoffs, and thus an embodiment of this system provides a timing signal to the backhauled nodes through the Remotes and through the Relay, in order to allow this synchronization. In an embodiment, synchronization management unit 734 obtains the synchronization signal from a Hub through the uphaul interface to perform the synchronization task through a comparison and feedback mechanism.

Backhaul Service Flow and Routing unit 735 ensures handling of each data element (for instance packets or TDM slots) and performs handling of those, in accordance with the pre-configured rules for such Backhaul Service Flows, as provisioned by a network operator. As described earlier in the description of FIG. 5A, such handling may include routing of information elements to various interfaces. An Element Management function 741 is implemented in order to implement all required management functions for the Relay and for collecting and providing management information to an external management or configuration server.

It should be noted that all the functional units described as part of the Routing and Relay unit are meant to represent functional entities, that can be implemented on one or multiple physical processors as part of an embodiment. In a particular case, these functions may be implemented on a single processor, also implementing some or all of the functions associated with the wireless processor as described above.

Backhaul Hub Unit description: FIG. 8C shows, in accordance with an embodiment of the system, the Backhaul Hub Unit arrangement, including a plurality of wireless hub radio modules 770, 772, and 774, representing the wireless hub radio modules for communicating wirelessly with the Backhaul Relay Modules of FIG. 7b, and a plurality of other uphaul interfaces 775 and 777 for connecting a plurality of Relays located remotely from the hub.

As shown in FIG. 7C, a Hub radio module (such as Hub radio module 770) includes a hub radio 776, which provides RF signals to an antenna 778. A baseband processing block 780 manages hub radio 776 through an internal interface 782. As noted in the case of the Backhaul Remote Module, the baseband processing module of the wireless access hub may use a standard protocol stack for the PHY and MAC layers, although some higher level protocol functionalities may be required to perform some of the functions required from a hub. Each Hub radio modules are connected via port 784 to Hub circuitry, which includes Radio Resources Management circuitry 785, Aggregation and Routing Management circuitry 786, and Network Interface Device circuitry 787, and backhaul port 788 for backhauling the information back to the core. The aggregation function in module 786 aggregates traffic from various Hub radio modules for backhauling to the core network while radio resource management 785 manages the radio resources of the various wireless access hub radio modules and their dependent modules. Port 784 is also the interface where the synchronization signal is being transmitted towards the rest of the network on the uphaul interface.

Other Interface Modules 775 and 777 have similar functionalities as the Hub Radios previously described, with specialized components for the medium and standard they are designed to operate with.

Network management port 790 enables management network information to be received for managing various aspects of the Backhaul Hub Unit as well as other network components. Functional block 789 provides all the functions required for managing the hub and providing network management information, for instance to a configuration server located remotely from the hub. Synchronization 792 represents a master synchronization block that obtains a unique time reference to provide synchronization to the plurality of Hub radio modules through port 784 or similar. This master synchronization signal is then employed by the synchronization function at each of the Relays to enable the Relays to synchronize with the rest of the network without requiring each of the Relays to obtain its own unique time reference (such as via its own GPS).

It should be noted that the description in FIG. 8C is meant as an illustrative example of an implementation of the Hub unit according to an embodiment of the system, and that there exists several other implementations.

While the description herein focuses on backhaul transmission from the Remote to the Hub and from there to the core network, it can easily be understood by one skilled in the arts that a symmetrical transmission and networking process can be accomplished in the opposite direction, in order to bring data from a core network towards remotes via a Hub and one or several Relays and from there to a data sink such as a cellular base station.

As noted previously, the uphaul interface may be implemented by using an in-band transmission mechanism. This is intended as a cost-reduction feature, in a particular embodiment of the current system. In this particular case, the same RF channel used for the downhaul point to multi-point interface is also used for the uphaul transmission links. The Relay allocates the wireless bandwidth to the backhaul and uphaul interfaces according to the aggregate traffic for all service classes in both directions. In the same way as for the case where a separate channel is used to implement the uphaul interface, the Backhaul Service Flow will determine the characteristics and handling by the Relay for the uphaul transmission in order to ensure end-to-end QoS and to maximize system efficiency.

Synchronization: In certain wireless systems, a network-wide synchronization scheme is required in order to reduce the amount of inter-cell interference. Such systems include cellular mobile networks using CDMA or OFDMA wireless technology. The purpose of this synchronization is to enable the wireless base stations to recover precise timing information in order to adjust its RF receive and transmit parameters. In addition, certain system may use network-wide synchronization in order to reduce inter-cell interference, or to facilitate the handoff or handover processes. The disclosed system provides a scheme for recuperating a synchronization signal from the various modules within the backhaul network, including the Remotes, the Relays and the Hubs.

An embodiment of the system relies on the use of a two-tier network topology, with a Relay between a point to multipoint downhaul interface and an uphaul interface. The nature of the downhaul interface is synchronous as it relies on a fixed duration frame structure, and on the scheduling of data elements by the Relay. As such, the Remotes use the fixed frame structure in order to synchronize to the same timing reference. In addition, the wireless transmission mechanism provides a mean to account for a variable timing advance to compensate for the effect of propagation delays. Synchronization of the Relay to a global timing reference may be achieved through an external timing reference, such as a GPS signal, or from the uphaul interface. In a particular embodiment of the disclosed system, a precise internal clock may be integrated within the Relay so as to minimize the requirement for re-aligning the timing reference at the Relay.

Synchronization of the Relay via the uphaul interface may be achieved either through Precision Time Protocol (IEEE 1588) from the timing reference available at the Hub, or through a proprietary in-band or out-of-band protocol using a synchronous connection between the Hub and the Relay. In an embodiment based on the later case, Backhaul Hub Unit 520 is capable of feeding back timing correction information in order to set or to correct the timing reference within the Relays 510a, 510b and 510c, when it detects that the timing reference of a particular relay module is off. One particular way of doing this is to provide this information as inband or out of band signals within the wireless interface.

As can be appreciated from the foregoing, embodiments of the system enable an efficient method for backhauling traffic from a highly distributed network of data sources and sinks, such as for example a cellular network consisting of macro, micro, pico and even femto cells. Use of at least two tiers within the backhaul network enables network operators to easily provision a wide range of sites in a wide range of environments. Use of on-demand bandwidth allocation as part of a Point to Multi-Point topology in the lowest level of the two-tier architecture takes advantage of the traffic characteristics and results in a lower cost of deployment and operation due to the reduced number of equipment and easier installation process. In addition, use of enhanced networking and classification techniques provide the highest flexibility for network operators to engineer and manage their networks, and to do so without requiring a physical visit to sites (known as “truck rolls”). Further benefits of networking techniques used as an integral part of the backhaul network include the ability to benefit from reduced use of the backhaul resource and reduced latency by optimal routing certain information element. The use of a synchronous interface at the Relays bring a further benefit for the network operator wanting to use the backhaul network to provide a timing reference for its network nodes. The possibility of using an in-band uphaul scheme sharing the wireless resource with the downhaul interface further decreases cost since such a scheme dispenses the use of separate radios and antennas, or the use of separate spectrum bands. The flexibility of a system using an embodiment of the system extends to the possibility of establishing redundant links at the various levels of the network within a short period of time, in order to meet high availability and fast change-over requirements typically imposed by network operators Service Level Agreements.

1. A backhaul network, comprising:
at least two tiers, a first tier further comprising one or more remote modules for providing backhaul capable of communicating with one or more relay modules in a point to multi-point mode;
a second tier that has one or more relay modules capable of communicating with a central hub for providing backhaul capabilities to the one or more relay modules and the one or more remote modules.

2. The network of claim 1, wherein the one or more relay modules and one or more remote modules are wireless.

3. The network according to claim 1, wherein each remote module, relay module and the central hub further comprises one or more pieces of software that ensure end to end control of quality of service attributes throughout the network.

4. The network according to claim 1, wherein each remote module further comprises a unit that inspects control information and user data transmitted and received over the network and that applies differentiated actions based on the result of the inspection.

5. The network of claim 4, wherein said remote module includes a circuit to assign a unique identifier based on the result of the inspection operation, and wherein said remote module further comprises an insertion unit that inserts this information into the control information before inspecting said user and control data.

6. The network according to claim 5, wherein said remote module further comprises a control unit that controls a quality of service from end to end of the network based on the inspection operation.

7. The network according to claim 1, wherein said central hub further comprises a unit that inspects control information and user data transmitted and received over the network and that applies differentiated actions based on the inspection results.

8. The network according to claim 7, wherein the central hub further comprises a control unit that controls a quality of service from end to end of the network based on the inspection operation.

9. The network of claim 7, wherein said central hub unit further comprises a circuit to assign a unique identifier based on the result of the inspection operation, and wherein said remote module further comprises an insertion unit that inserts this information into the control information before inspecting said user and control data.

10. The network according to claim 1, wherein each remote module further comprises a unit that monitors the quality of a wireless channel used to communicate with the one or more relay modules and concurrently monitors the quality of at least another wireless channel.

11. The network according to claim 10, wherein each remote modules further comprises a unit that reports a list of relay modules which they have measured to have acceptable transmission conditions.

12. The network of claim 11, wherein each relay module is configured to receive the list of other relay modules from the one or more remote modules and to inform, based on the list of other relay modules, adjacent relay modules and the central hub about remote modules that may connect said neighboring relay modules, by transmitting a signaling message to said relay modules and the central hub.

13. The network of claim 12, wherein each remote module further comprises a unit that establishes a new connection to one of the neighboring relay modules on a channel with which it has determined that transmission conditions were acceptable, upon detecting a failure with the active link towards the currently serving relay module.

14. The network of claim 12, wherein each remote module further comprises a unit that establishes a new connection to one of the neighboring relay modules on a channel with which it has determined that transmission conditions were acceptable, upon receiving an instruction from a serving relay module to change channel.

15. The network of claim 1, wherein each relay module further comprises a unit that receives a message containing a list of remote modules susceptible to establish a connection towards it, and to determine service configuration parameters associated with remotes in said list.

16. The network of claim 1, wherein each relay module further comprises logic allowing it to reserve wireless and processing resources on its various interfaces in order to accommodate additional traffic calculated from the list of service requirements determined to correspond to remotes in the list received from another relay module.

17. The network of claim 1, wherein each relay module further comprises a unit that is capable of granting access to a plurality of remote modules in a minimum time, by broadcasting a grant message and pre-allocating time and frequency resources for accommodating said plurality of remote modules.

18. The network according to claim 1, wherein each remote module, each relay module and each central hub further comprises a routing unit configurable based on application or protocol specific criteria.

19. The network of claim 1, wherein each remote module further comprises a unit to use a time reference provided by a Point to Multipoint interface as a source of synchronization for external equipment.

20. The network of claim 1, wherein each relay module further comprises a unit that maintains synchronization with a timing reference located within the central hub unit.
